(19) United States
(12) Patent Application Publication
(10) Pub. No.: US 2002/0055936 A1
(43) Pub. Date: May 9, 2002

(54) Knowledge discovery system

(75) Inventors: Choong Hung Viktor Cheng, Singapore (SG); Soo Yin Cheng, Singapore (SG)

Correspondence Address: GREENBLUM & BERNSTEIN, P.L.C., 1941 ROLAND CLARKE PLACE, RESTON, VA, 20191, US

(73) Assignee: KENT RIDGE DIGITAL LABS, Singapore (SG)

(21) Appl. No.: 09/931,882

(22) Filed: Aug. 20, 2001

(30) Foreign Application Priority Data
Aug. 21, 2000 (SG) 200004781-1

(51) Int. Cl. G06F 7/00

(52) U.S. Cl. 707/104.1; 707/1

(57) ABSTRACT

A computer-implemented method of generating a user personalized filter for processing files is disclosed, the method comprising the steps of:

(a) establishing communication with a server;

(b) employing at least one software tool operated by the server to generate a personal profile, the profile comprising one or more topics, and associated with the or each topic, at least one keyword and at least one text document; and

(c) employing processing software operated by the server to generate, for the or each topic, a filter from the associated keywords and text documents.

### FIELD OF THE INVENTION

The present invention relates to a system, having apparatus and device aspects, for personalising automated knowledge discovery in relation to items stored in a database. In particular the invention relates to methods of training and modifying the system.

### BACKGROUND OF THE INVENTION

It is known to personalise the search carried out by a knowledge discovery system in accordance with the characteristics of a user who instructs the search. In each of U.S. Pat. Nos. 5,428,778, 5,761,662 and 5,890,152, a user is permitted to generate a personal profile by selection of one or more predetermined options, such as topics or keywords, and items of a database are scanned in relation to those options.

For example, in U.S. Pat. No. 5,428,778 a user selects a personal list of keywords from a hierarchically arranged set to generate an interest profile. Each user is alerted to the presence of information items with keywords which match the selected keywords. This system suffers from the disadvantage that if a user's interests are not adequately covered by the predetermined options, then the search cannot be well adapted to the user.

In U.S. Pat. No. 5,890,152 a user's profile consists of a set of keywords each associated with a weighting factor selected by the user. The weighting factors are used to produce a numerical assessment of the relevance of a data item to a given user, as a function of the occurrence of the keywords of the profile in the data item weighted by the weighting factors. However, there will always be a proportion of users who have difficulty understanding the concept of weighting factors.

U.S. Pat. No. 5,717,923 describes a system in which each user is associated with a profile, and that profile is updated automatically according to correlations in the pages the user actually accesses (e.g. correlations in terms used in the headers of those pages). The same profile also permits a limited personalisation of the style in which pages are present to a user, e.g. according to a colour scheme defined by the profile. One disadvantage of this system is that it is not useful until the user has accessed a sufficient number of pages for the correlations to be statistically significant.

### SUMMARY OF THE PRESENT INVENTION

The present invention seeks to provide new and useful apparatuses and methods for automated knowledge discovery.

In a first aspect, the invention proposes that a user's profile is generated using one or more text documents (which may or may not be limited to plain text) and a set of keywords. At least one weighting value may be determined for each of the keywords based on occurrence of the keywords within the text document(s). Preferably, this operation further employs setting at least one numerical parameter, which may be used to process new items from a database.

In a second aspect, the invention proposes that a profile for a single user comprises more than one topic, each topic being suitable for processing data items from a database, and that the user has the option of modifying one topic using data from at least one other topic. This modification process may, for example, result in the creation of a completely new topic which is a combination of two or more pre-existing topics.

Each of the aspects can be expressed as a method, a computer apparatus which facilitates the method, or a computer program product readable by a computer apparatus to cause it to facilitate the method. In any case, the preferred aspects of the method, explained below, are the same.

Definitions

A personal profile is here defined as comprising one or more topics, and associated with each topic a set of entities. Each entity is one of: a list of keywords, a list of full text documents, a list of free text documents or a set of software parameters (in principle any of these lists can be shared between two closely related topics, but this is not preferred). The personal profile preferably also comprises, for each topic, a summary portion, which is derived from the entities, and which is the portion of the profile which is employed to process items in a database in accordance with that topic.

A kernel is a system which employs at least a portion of the personal profile (e.g. a summary portion) to process (e.g. categorise or summarise) items in a database.

A topic is a category of knowledge describing a focused information interests or needs of the readers. A given topic is associated with one or more keywords, one or more text documents (free text documents and/or full text documents), and (preferably) one or more software parameters in the user's profile.

A keyword is defined as a single English word, a combination of single English words or a phrase.

A full text document is a single software file or URL. Normally, it contains only ASCII characters and words in such a way that it describes a concept or a subject of knowledge.

A free text document is like the full text document except that it is allowed to contain multimedia objects.

A software parameter is defined as a numerical value, such as a threshold value. As explained in detail below, a threshold value allows a user to command the behaviour of a kernel during content processing.

The term “database” is used in this document to include within its scope not only a database in a single physical location or defined by a single data storage device (e.g. server), but a network of (physically separated) data storage devices, such as the world wide web.

User content personalization system (“UCPS”), also referred to more simply here as user personalisation, refers to setting of the user profile by the respective user.

Content personalization processing is defined as the generation of personalized publication by the system kernel for each respective reader using the reader's personal profile created during user personalization. That is, content personalization processing involves the results of user personalization in content processing in order to generate a unique and private personalized publication for each and every user of the system.

### BRIEF DESCRIPTION OF THE DRAWINGS

The present invention will now be described, for the sake of example only, with reference to the following figures, in which:

FIG. 1 is a schematic view of a system employing profiles generated according to an embodiment of the present invention;

FIGS. 2a-c illustrate the structure and formation of a personal profile for a user in an embodiment of the invention;

FIGS. 3a-c illustrate other aspects of the structure of the personal profile of FIG. 2;

FIGS. 4a&b illustrate use of the profile of FIG. 3;

FIGS. 5a&b illustrate updating the profile of FIG. 3;

FIGS. 6a&b illustrate stimulation of the updating process of FIG. 5 by a user;

FIGS. 7a&b show a flow diagram for creating a topic for the profile of FIG. 2;

FIGS. 8a&b show a flow diagram for updating a topic for the profile of FIG. 2;

FIGS. 9a&b shows a flow diagram for skewing a topic for the profile of FIG. 2;

FIGS. 10a&b illustrate the process of FIG. 9;

FIGS. 11a&b show a flow diagram for merging topics for the profile of FIG. 2;

FIGS. 12a&b illustrate the process of FIG. 11;

FIG. 13 illustrate the process of removing a topic of the profile of FIG. 2;

FIG. 14 illustrate the process of renaming a topic of the profile of FIG. 2;

FIGS. 15a-c illustrate how keywords in the profile of FIG. 2 may be changed;

FIGS. 16a-c illustrate how full text documents in the profile of FIG. 2 may be changed;

FIGS. 17a-c illustrate how free text documents in the profile of FIG. 2 may be changed;

FIGS. 18a-c illustrate how parameters in the profile of FIG. 2 may be changed;

FIG. 19a-c illustrate the formation of clusters and multiple document summaries using the profile of FIG. 2;

FIGS. 20a&b illustrate how a user employs the multiple document summaries of FIG. 19 to select a single document, viewing successively a summary of the document and then the document itself; and

FIGS. 21a&b summarise the content personalization of the knowledge discovery device of the embodiment.

### DETAILED DESCRIPTION OF EMBODIMENTS

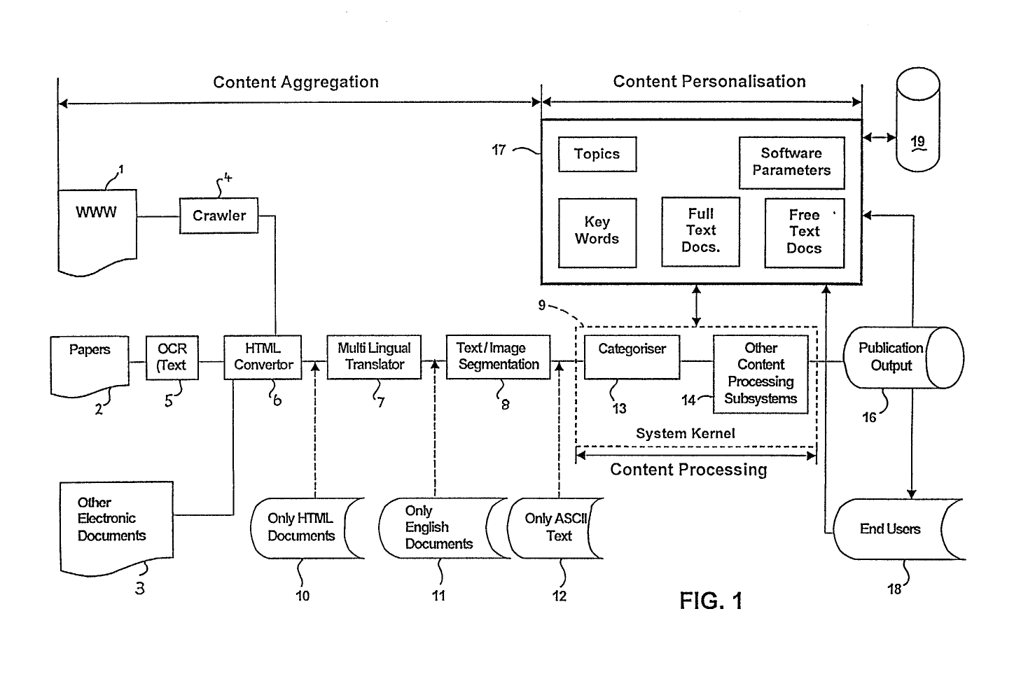

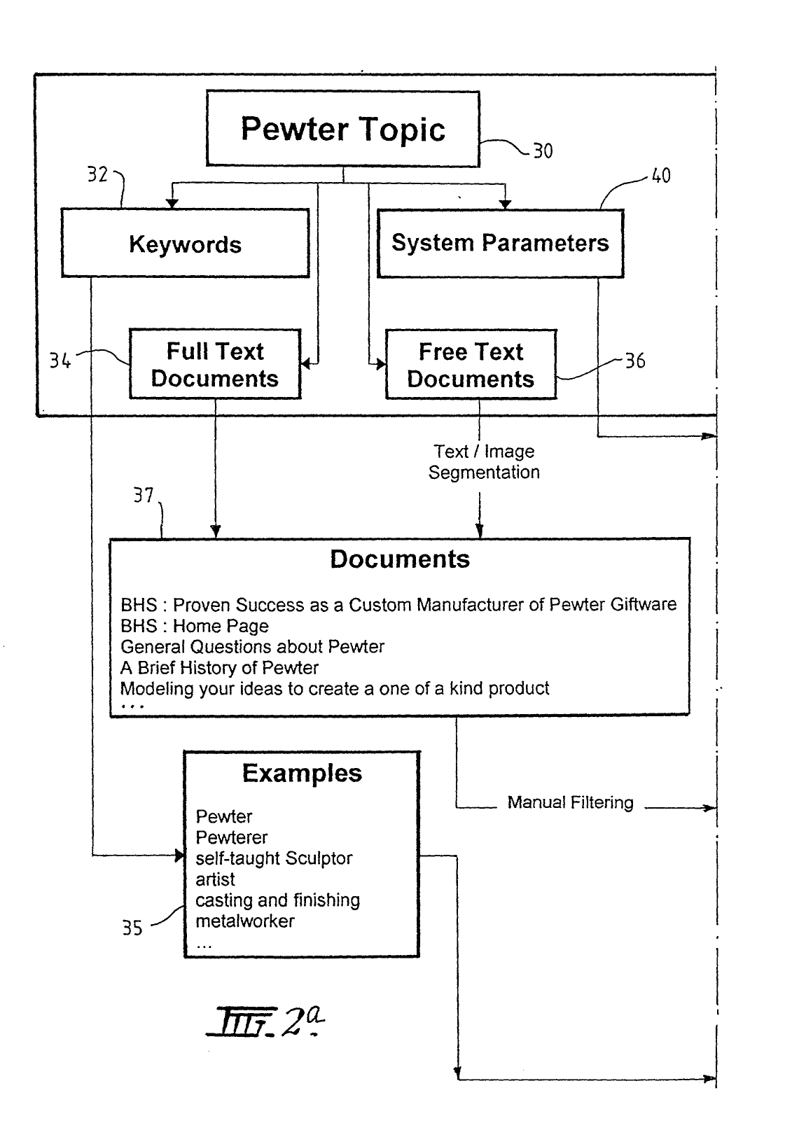

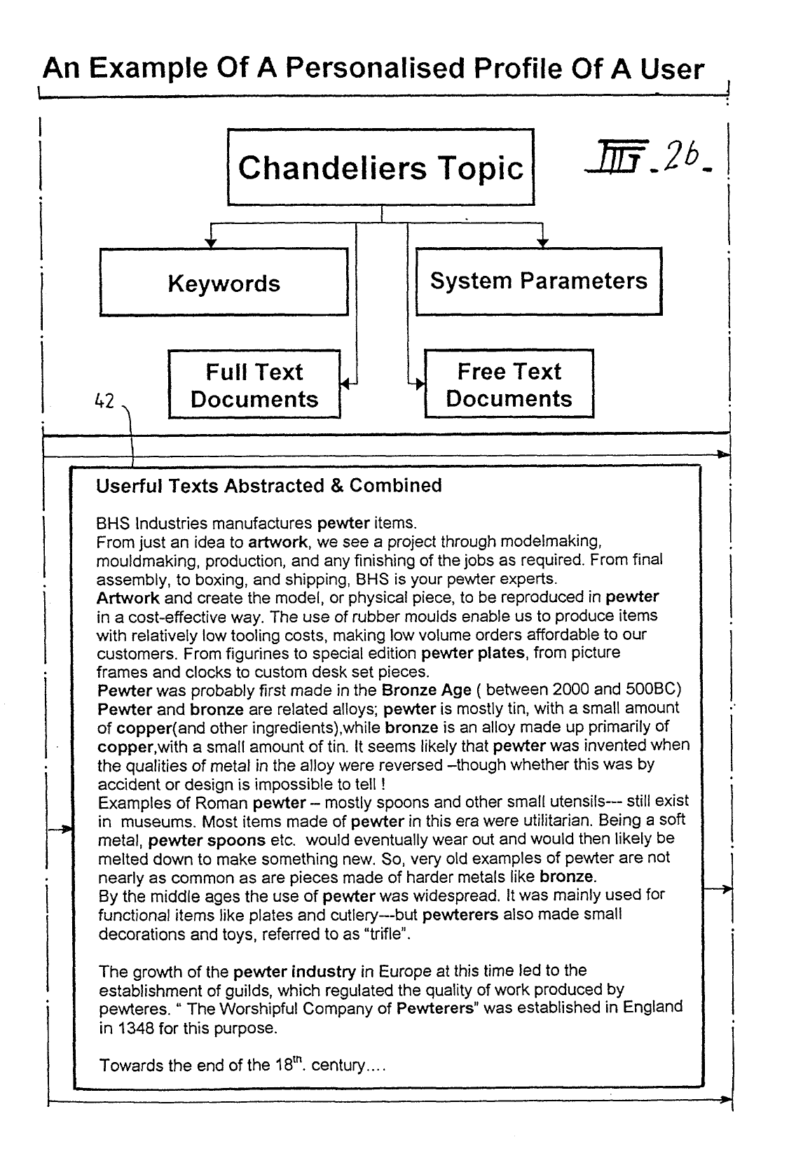

FIG. 1 illustrates schematically a system employing profiles generated according to the present invention. Information sources from the world wide web (WWW) 1, databases of papers 2 and other electronic documents 3 are accessed. Data items (e.g. data files) from these sources are obtained in an electronic format, for example from crawler 4, OCR 5 or from any other source. Each data file (herein also referred to as a document) is considered an item in a database from which it was obtained.

Once obtained in an electronic format, all documents will be converted into HTML format for further processing steps by a HTML converter 6. A multi-lingual translator 7 can be used to convert HTML document contents into a single language form, say English. Multimedia objects like images, pictures, sound, videos and audio are removed by a text/image segmentation module 8. The output of this module 8 are pure ASCII texts. This completes the Content Aggregation Process steps in FIG. 1. As indicated by boxes 10, 11, 12, documents which do not need to be processed in this way (because they are already in a suitable format) can be introduced into the stream at the appropriate points.

The pure ASCII texts will be filtered, analyzed, clustered and summarized by the system kernel 9. Initially, the kernel 9 operates on the basis of a pre-set profile set by the administrator of the system. The pre-set profile defines a number of categories, and ways of recognising whether a given document falls into each category. For example, it may include a set of keywords for each category, and weightings for each keyword, so that the conformity of each document to each category may be derived as a numerical function which is the sum over the keywords in the category of their incidence in the document weighted by the weighting factor. Thus, using the pre-set profile, the kernel 9 categorizes each document, using a module 13, into the most relevant categories.

By a similar process, categorized documents in each category may be analyzed and clustered into various themes. Documents within each cluster may be summarized as a group by a module 14 to generate multi-document summaries for this cluster.

This completes the content processing steps in this system.

The output of the content processing steps is the final publication 16 delivered to all readers (users) 18. For simplicity, only one reader 18 is shown. While reading the publications, readers 18 are provided with a suite of special tool sets for them to perform content personalization. A set of tools, represented in the grey box 17 is called the user content personalization system. Each user 18 interacts individually with the user content personalization system 17 to define and/or modify one or more topic(s) for that user, as described in detail below. The system 17 stores them in a database 19. The system 13 further includes integration & management software subsystem to generate the personal profiles stored in the database 9 from the user's interaction with the tools.

Once the personal profiles are defined, the system 17 interacts with, and influences or controls, the system kernel 9. Thus, in respect of that user, the kernel operates on the basis of the respective profile (or one of the plural profiles) of the user. In effect, it operates as above, but using the user's profile to replace (or supplement) the pre-set profile discussed above.

Content personalization is defined as a process providing each reader with a set of tool sets that gives him ability to define, to create, to update and to remove his personal profile. This is the only feedback loop for each user to inform the user content personalization system 17 about his unique and private information needs and interests. All activities involved in content personalization are described in detail below. Preferably, as described below, the system kernel 9 is itself used by the user content personalization system 17 to provide the personal profile of each reader during content personalization processing.

In short, in order to produce a personalised publication for himself, each user performs content personalization in order to indicate his interests and needs, and that information is stored in his personal profile in database 19. Content personalization is performed using the tool sets provided by the user content personalization system 17. The interaction between users 18 and the user content personalization system 17 are governed by the integration and management software subsystem within the user content personalization system 17. Once the personal profile has been created for the reader 18, the system kernel will be activated at a pre-determined time interval to retrieve the user's personal profile from the database 19, and to generate his unique and private personalised publication automatically. The activation of the system kernel for content personalization processing is preferably controlled by the same integration and management software subsystem used by the user content personalization system 17.

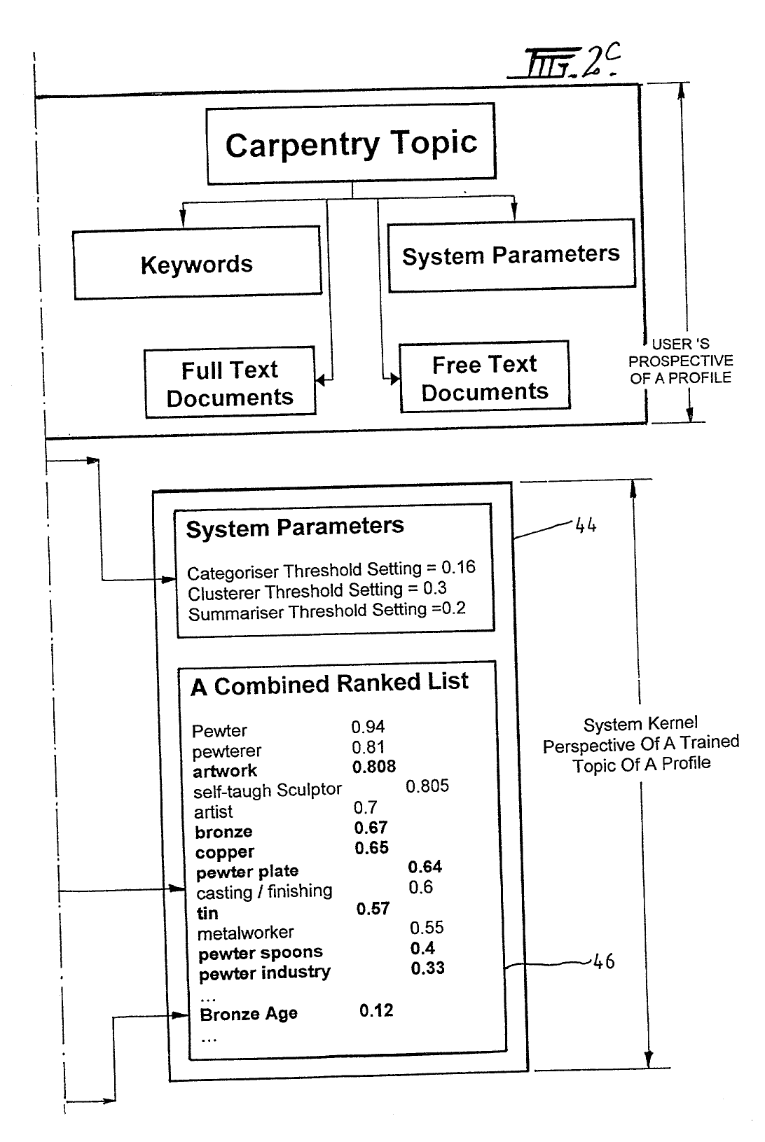

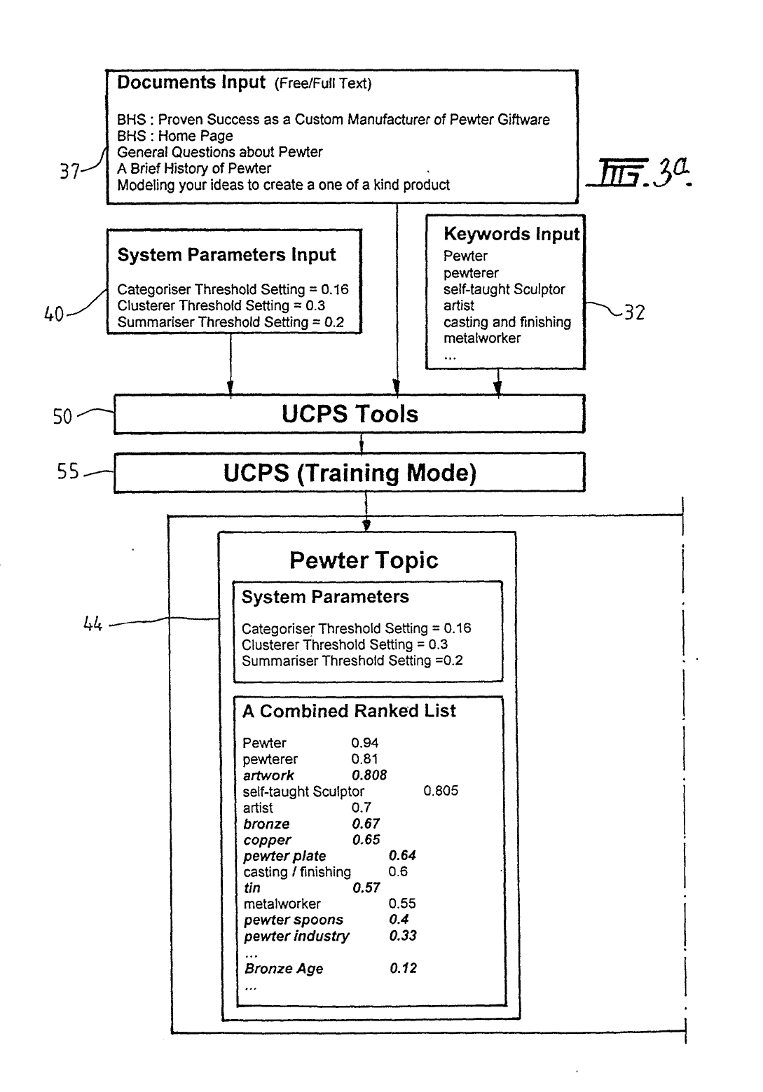

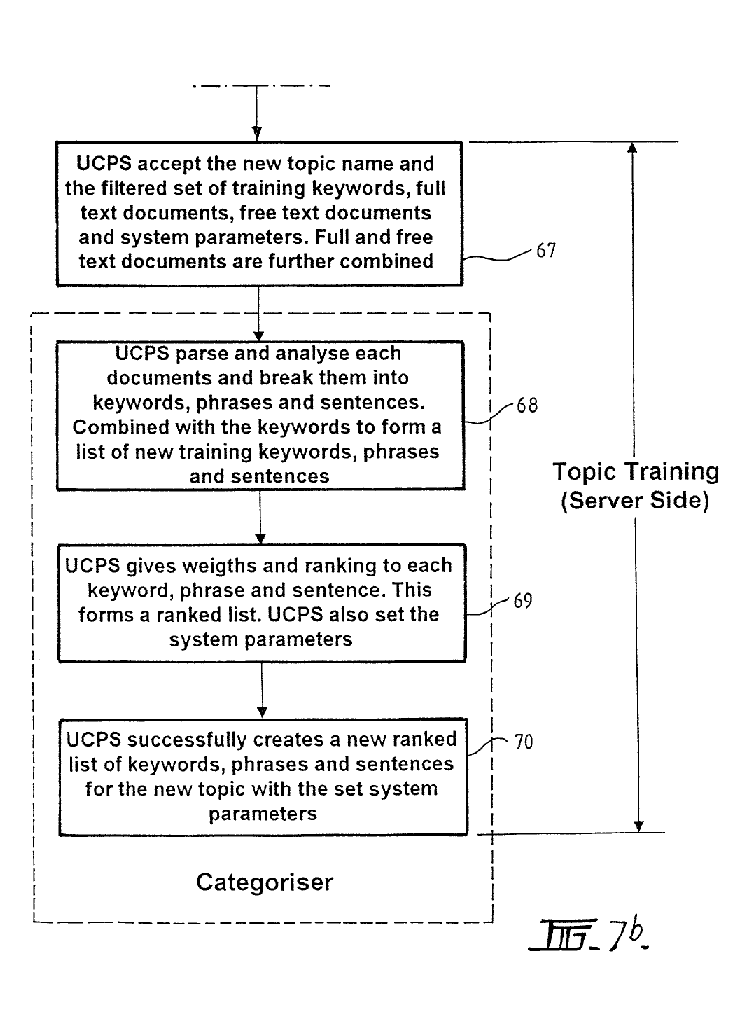

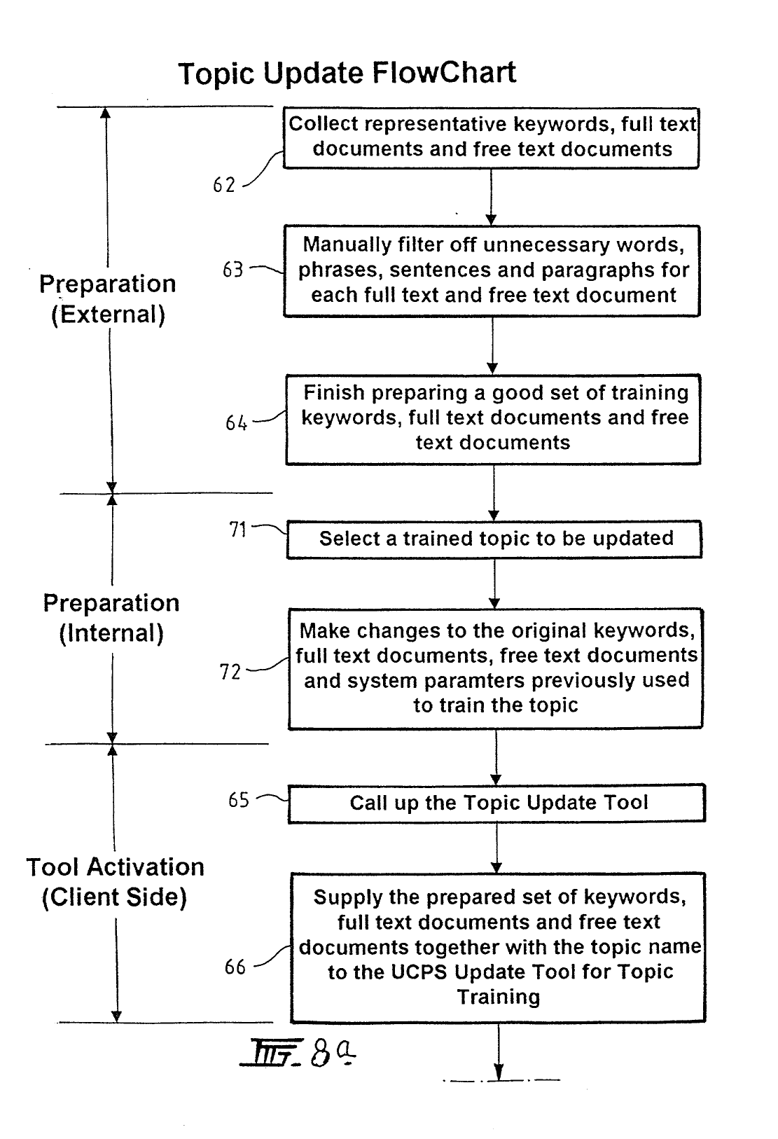

Referring to FIGS. 2 to 6, we will describe the invention in conceptual terms. Then, with reference to FIGS. 7 to 17 we will describe the processes underlying the invention using flow diagrams.

Specifically, referring to FIG. 2, a profile of a certain user (e.g. stored in the database 19) is shown schematically to include three topics, “pewter”, “chandeliers” and “carpentry”. FIG. 2 shows the structure of the record for the topic “pewter”.

The record includes a name 30, a set 32 of keywords. The record further includes one or more full text documents 34 or location references of such documents, and one or more free text documents 36 or location references of such documents. The record further includes a set of system parameters 40. In this example, this inludes a categorizer threshold, a cluster threshold and a summarizer threshold.

For the sake of explanation, FIG. 2 illustrates some of the set 32 of keywords in box 35, and titles of some of the documents in box 37. The full text (i.e. ignoring images) of these documents is obtained (as shown in box 42), optionally edited by the user to filter out portions of the documents which he does not regard as relevant. The occurrence of the set 32 of keywords in the text shown in box 42, is used to generate a ranked list of keywords 46, each associated with a weight (shown on the right hand side of box 46). The ranked list 46 and the system parameters 40 constitute a summary portion 44 of the profile for the topic “pewter”, which is what the kernel 9 uses to analyse the compatibility of database items with the topic. Since the generation of the summary portion 44 is automatic, the user is not required to understand the concept of weighting.

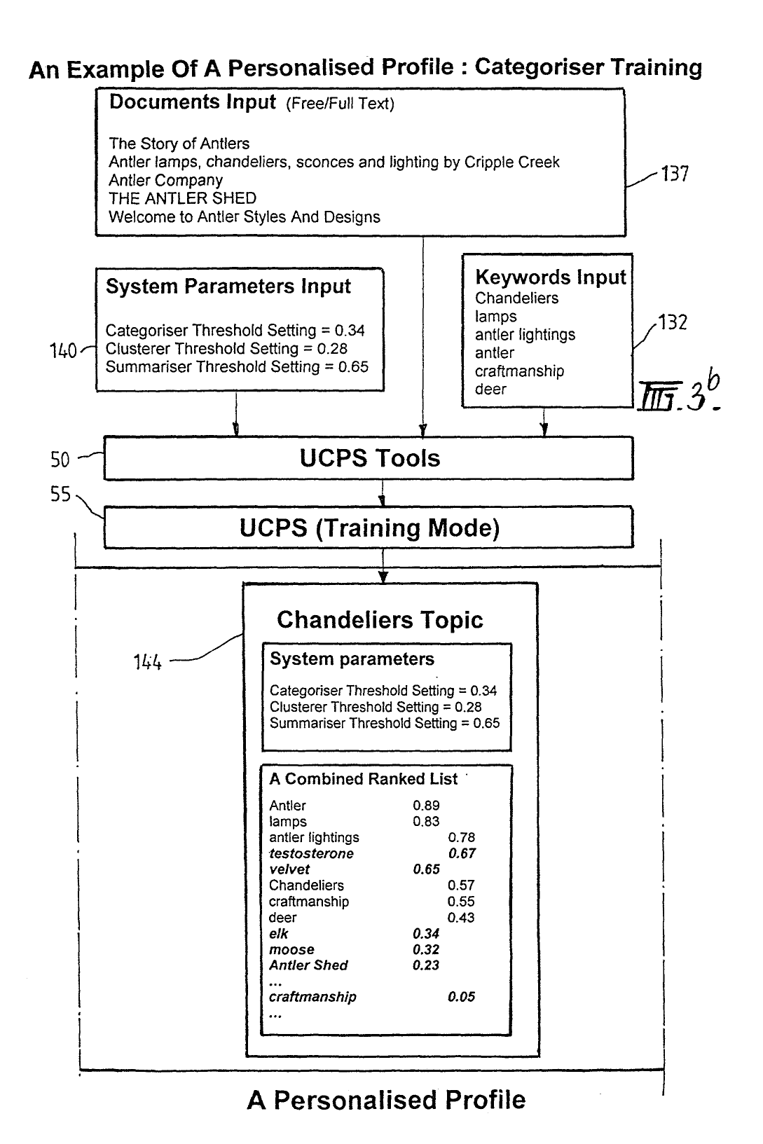

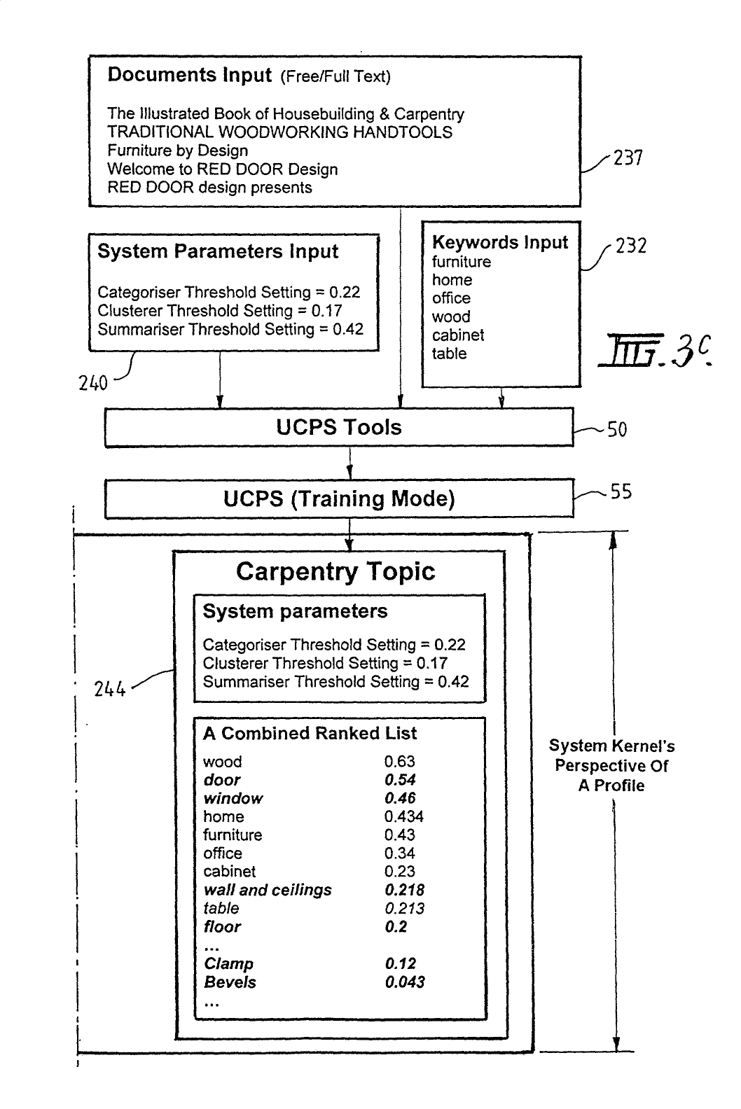

FIG. 3 illustrates the user personalization process (user content personalisation system, UCPS) for each of the same user's three topics. As explained above, the three topics are associated with a respective set 32, 132, 232 of keywords, a respective set of documents 37, 137, 237 and a respective set of system parameters 40, 140, 240. The UCPS tools 50 explained below are used to input or modify this information. Then there is a step explained above of using the information to generate the summary portion 44, 144, 244 for each topic.

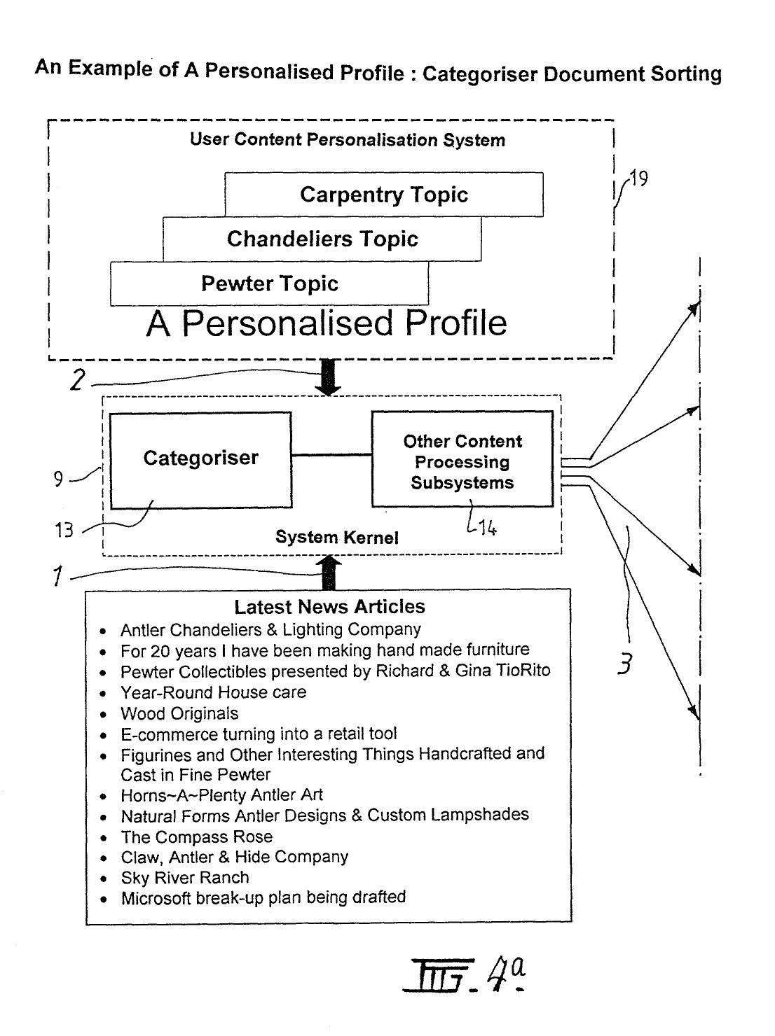

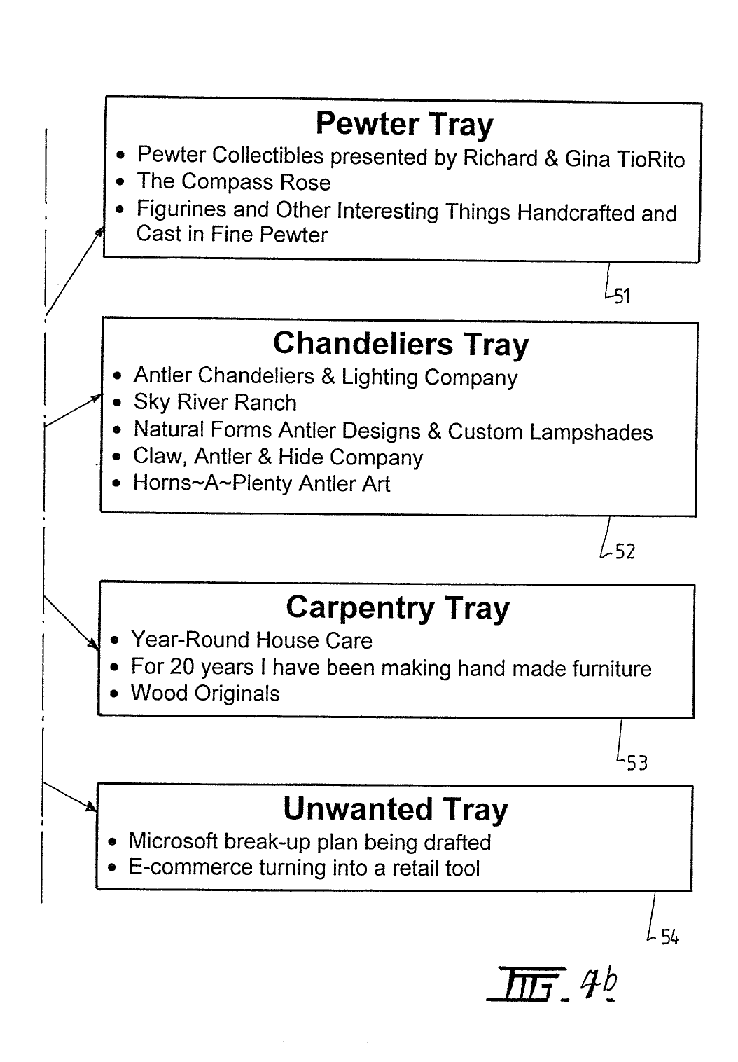

FIG. 4 shows how the kernel 9 uses the profile summaries to sort documents. Each topic is associated with a box 51, 52, 53. A set of new documents (e.g. drawn from sources 1, 2, 3 on FIG. 1), are passed in step 1 to the kernel 9. In step 2 the kernel 9 accesses within database 19 the profile for the user, based on the three topics. The kernel uses the summary portions of the profile, to determine for each topic a relevance index (e.g. a sum over the keywords of the topic of product of the weightings for that keyword in the summary portion for the topic, with the occurrence of the keyword in the document). Any document for which the relevance index is below the categorizer threshold setting for all three topics is placed in the “unwanted tray” 54 (i.e. effectively deleted from the system, as far as that user is concerned). For other documents, the document is placed in the box 51, 52, 53 associated with the respective topic for which the relevance index is highest (of those topics for which the relevance index is above the categorizer threshold).

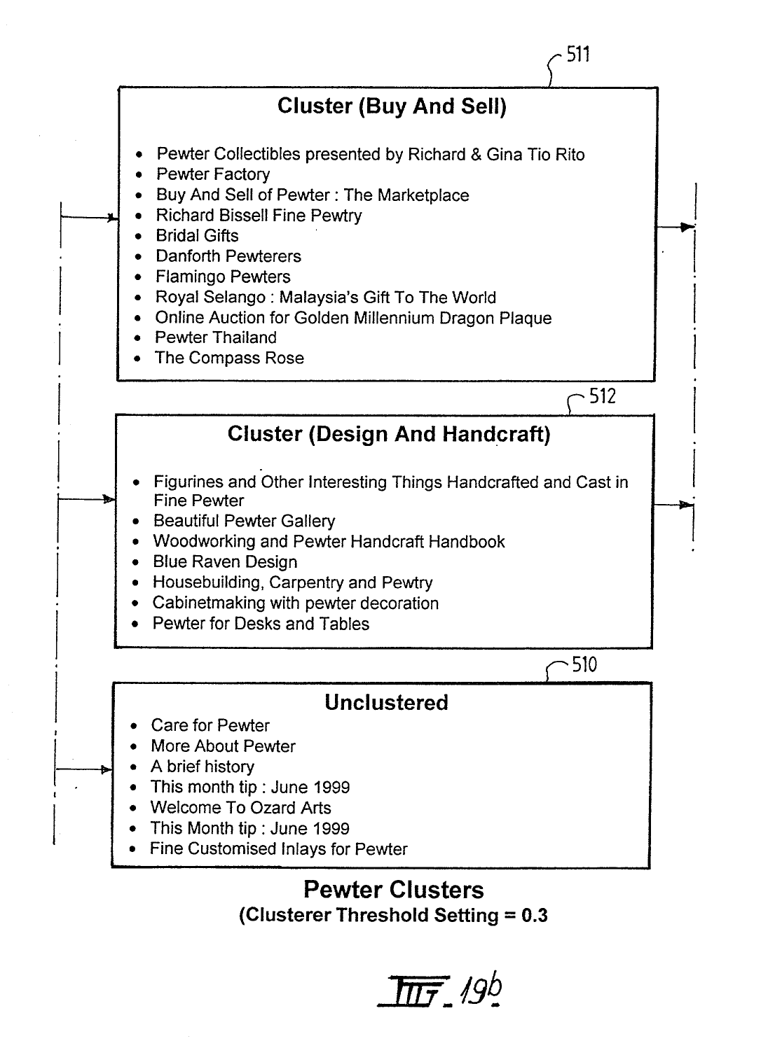

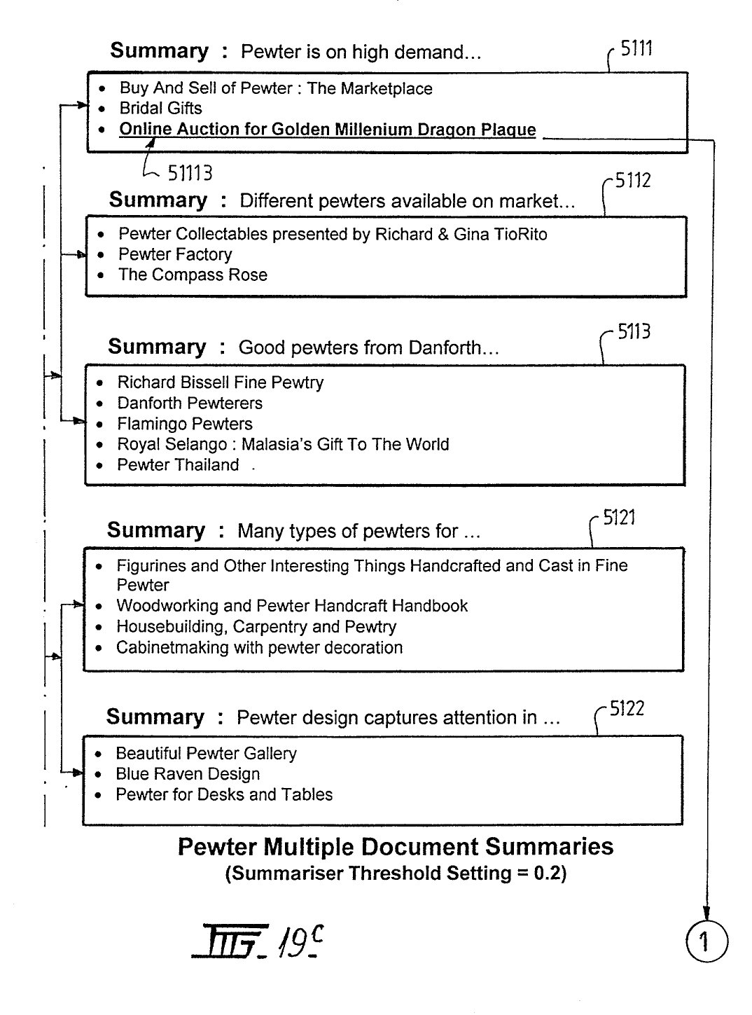

Note that the sorting in FIG. 4 has employed the categorizer 13 of the kernel 9. The other content processing subsystems 14 have not been employed (indeed their use is optional). The functioning of these other systems is described below with reference to FIGS. 19 to 21.

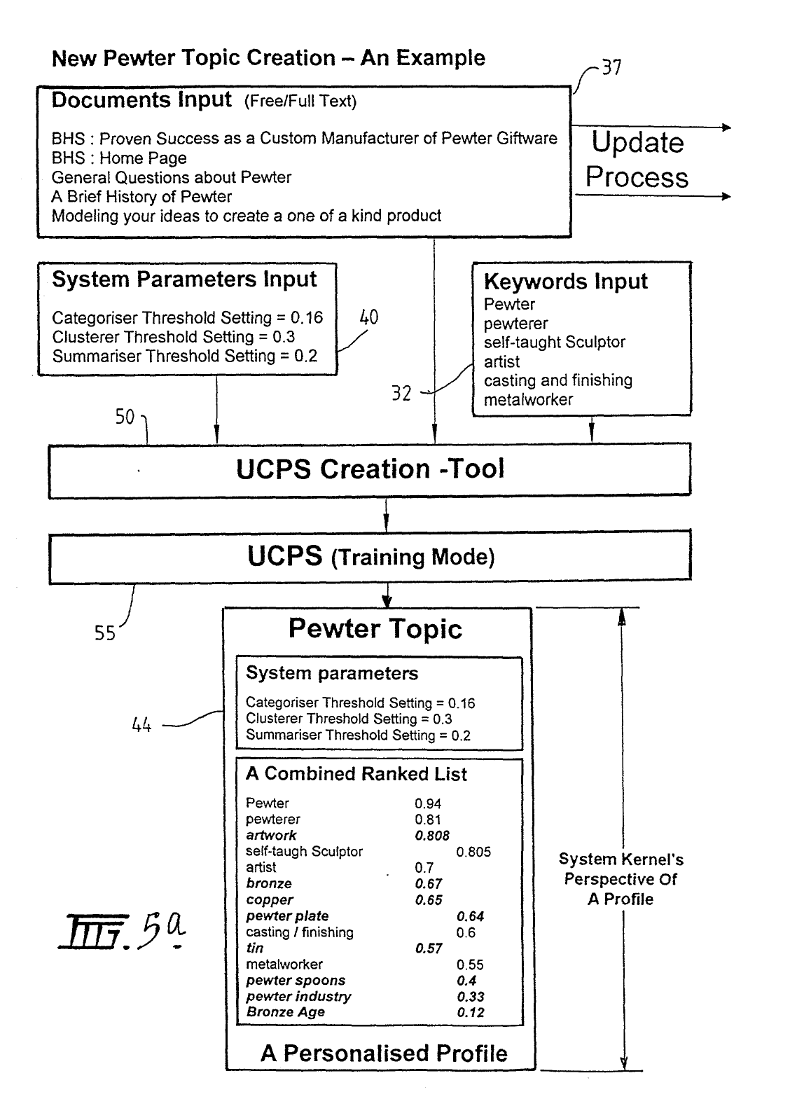

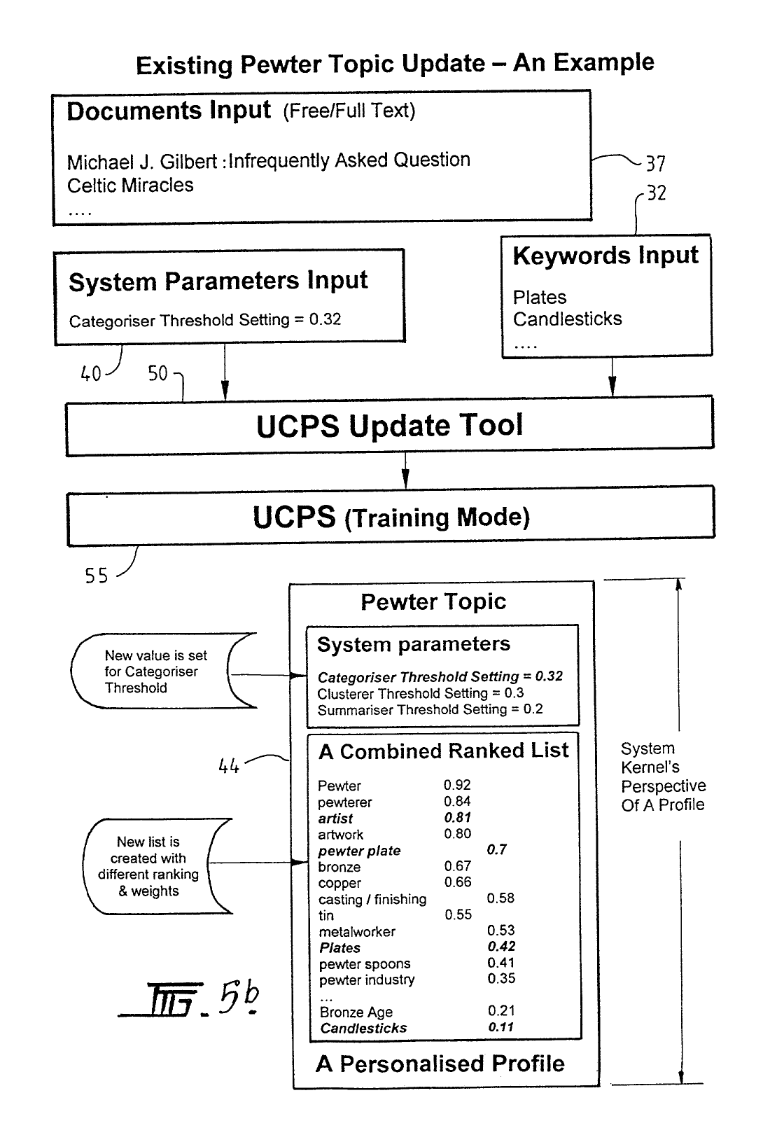

FIG. 5 illustrates schematically the profile update process. The user's profile with respect to the topic “pewter” is updated (by processes explained in detail below) by updating the set of documents 37 and the categoriser threshold (from 0.16 to 0.32). This updating uses the UCPS tool, as explained below. There is then a step 55 of generating a revised version of the summary portion 44 for the profile.

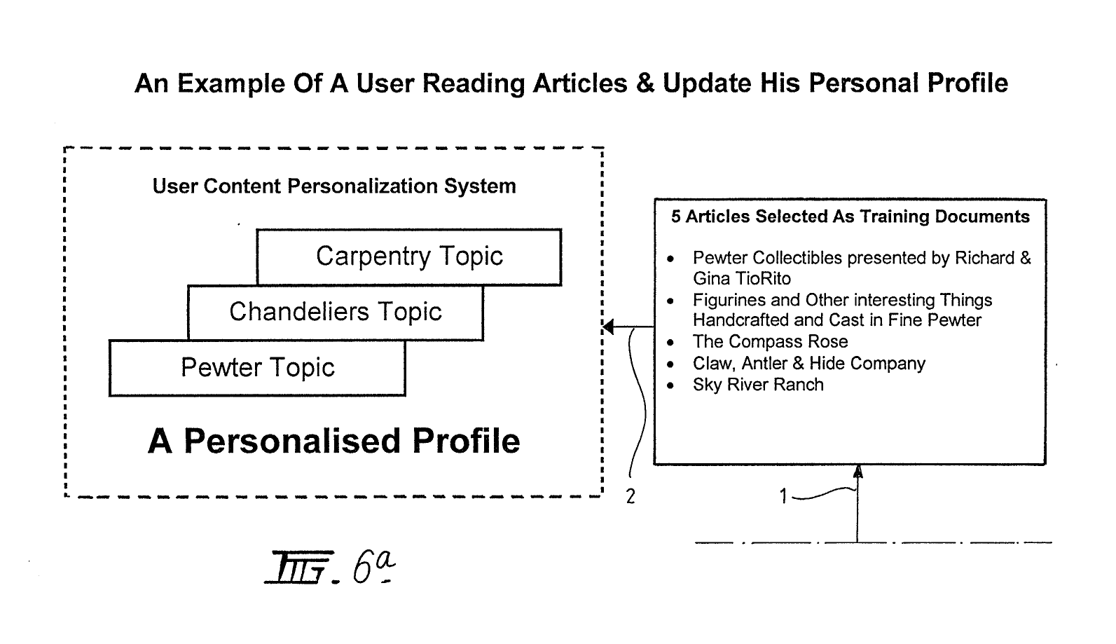

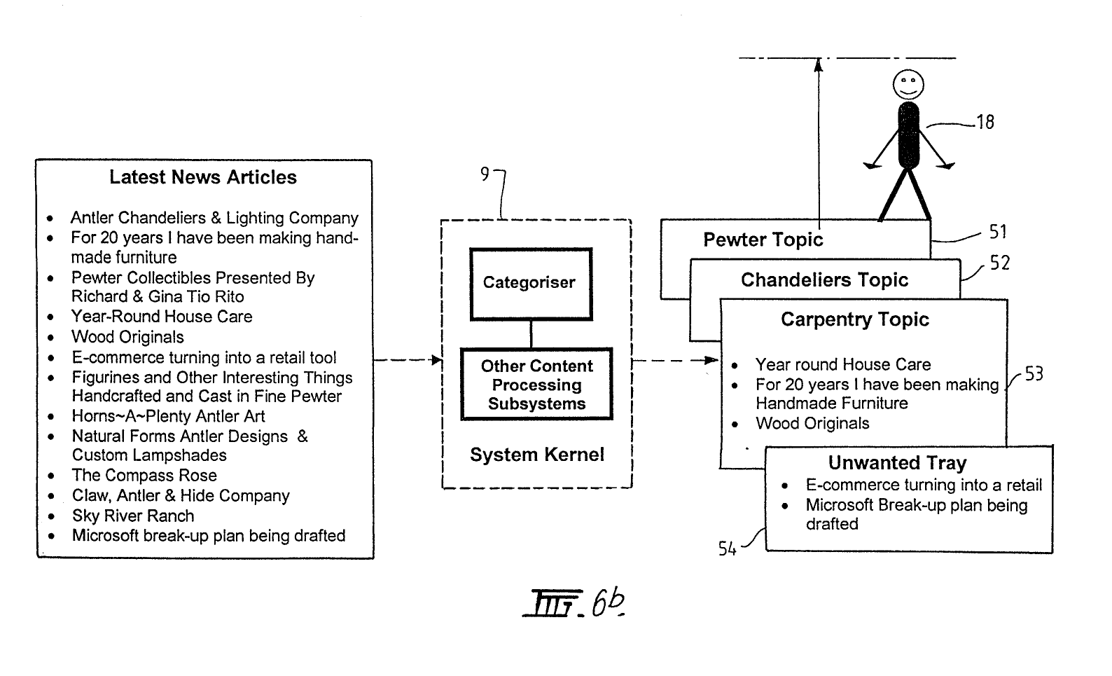

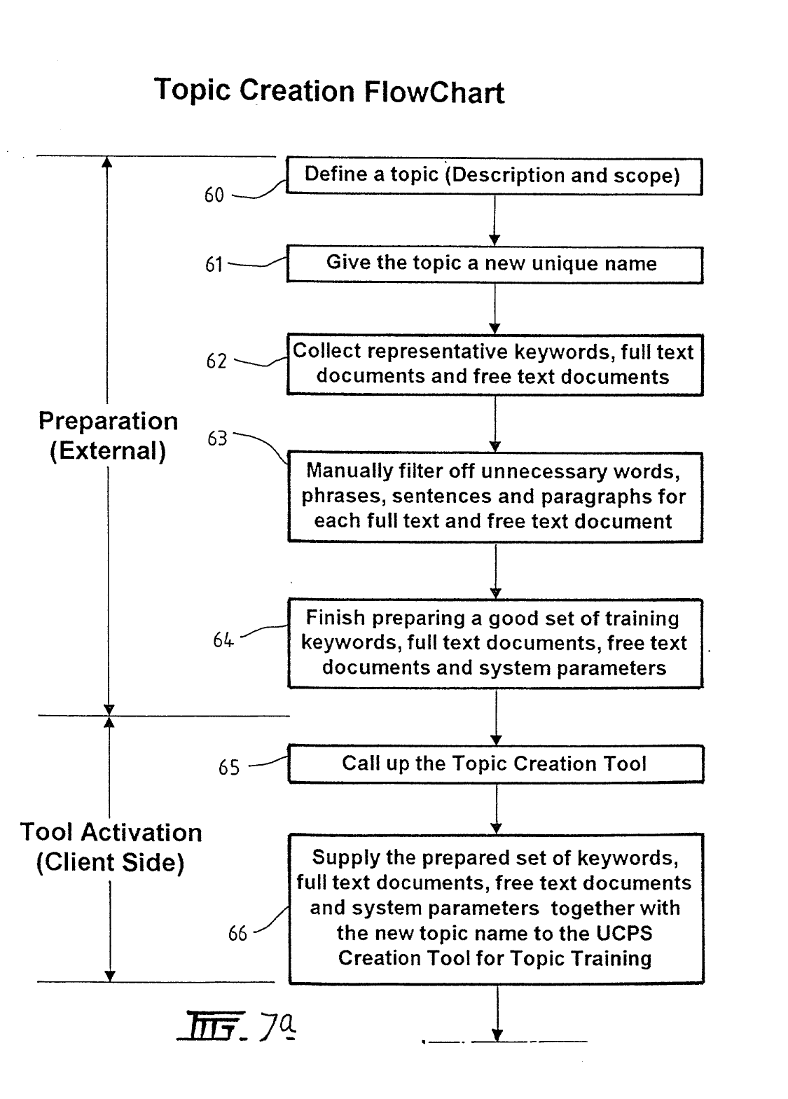

FIG. 6 shows a process in which a user updates his profile, using the new documents sorted by the kernel itself. As explained with reference to FIG. 4, a set of new documents is sorted into the three trays 51, 52, 53 based on the present profile. Documents relevant to none of the user's existing topics are discarded to the unwanted tray 54.

In a step 1, the user 18 selects documents, from the tray for a given topic, to improve the profile for that topic. For example, he may select documents from the tray 51 to add to the set of documents 37 (shown in FIG. 5). The updating illustrated in FIG. 6 may then be carried out.

We now turn to a more detailed discussion of the generation and updating of the profiles, using the UCPS tools 50.

Topic Creation

Each topic can be created and manipulated by a set of topic tools. They are the Create, Update, Skew, Merge, Remove and Rename.

Create: It allows readers to define new topics of interests. A topic name can be a single word or a short phrase. While it is created, training keywords, free text documents and full text documents can be input. Topic is trained after creation. The process is shown in FIG. 7. In step 60 the user indicates that he wants to define a new topic; in step 61 he names it; in step 62 he collects entities for it; in step 63 he manually removes unwanted parts of the documents; in step 64 he finishes preparing the entities by setting the system parameters. In step 65 he calls up the topic creation tool, in step 66 he feeds in the data derived in step 64, in step 67 the UCPS reads it in; in steps 68 to 70 performs the process 55 (see FIG. 5) described above in relation to FIG. 2 of generating the summary 44.

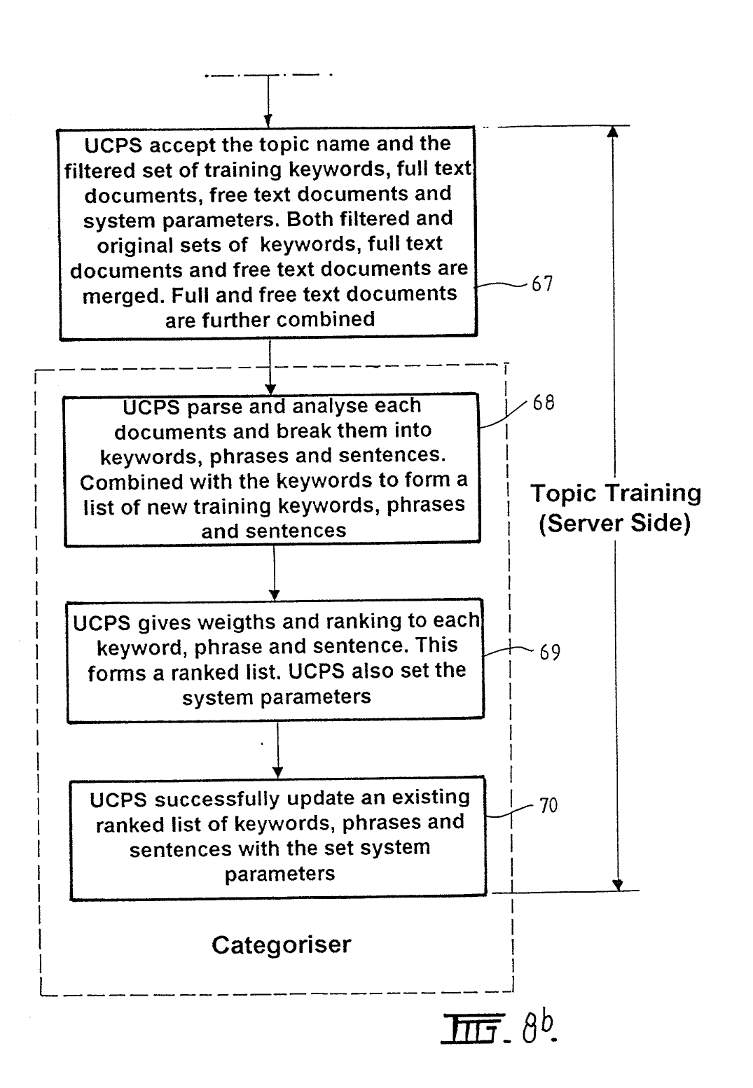

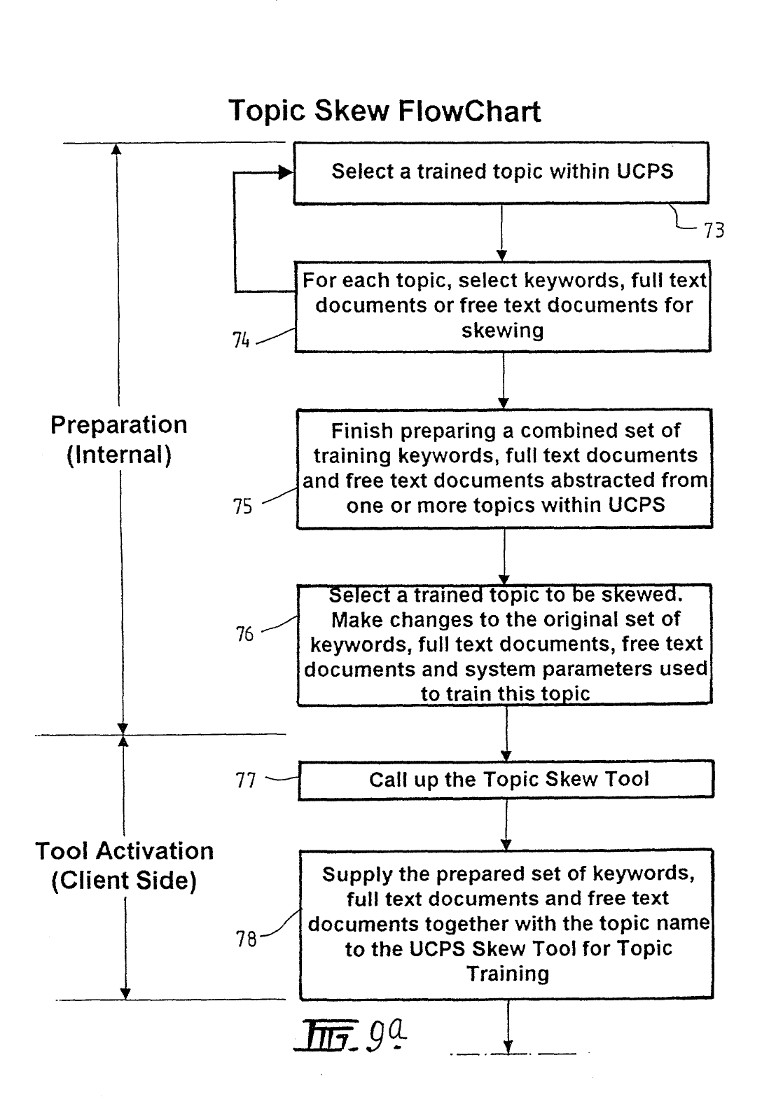

Update: Readers are allowed to modify the exact content of the training keywords, full text documents and free text documents. Modification can involve change of spellings, grammatical correction, change of words, phrases, sentences, paragraphs or the whole document content. Update operation is performed within a single topic. The process is illustrated in FIG. 8. Steps 62, 63, 64 of FIG. 2 (which set the topic in the first place) are supplemented with step 71 of selecting a topic to be updated, and step 72 of changing the entities for that topic in the database 19. Steps 65 to 70 of FIG. 7 are then performed again.

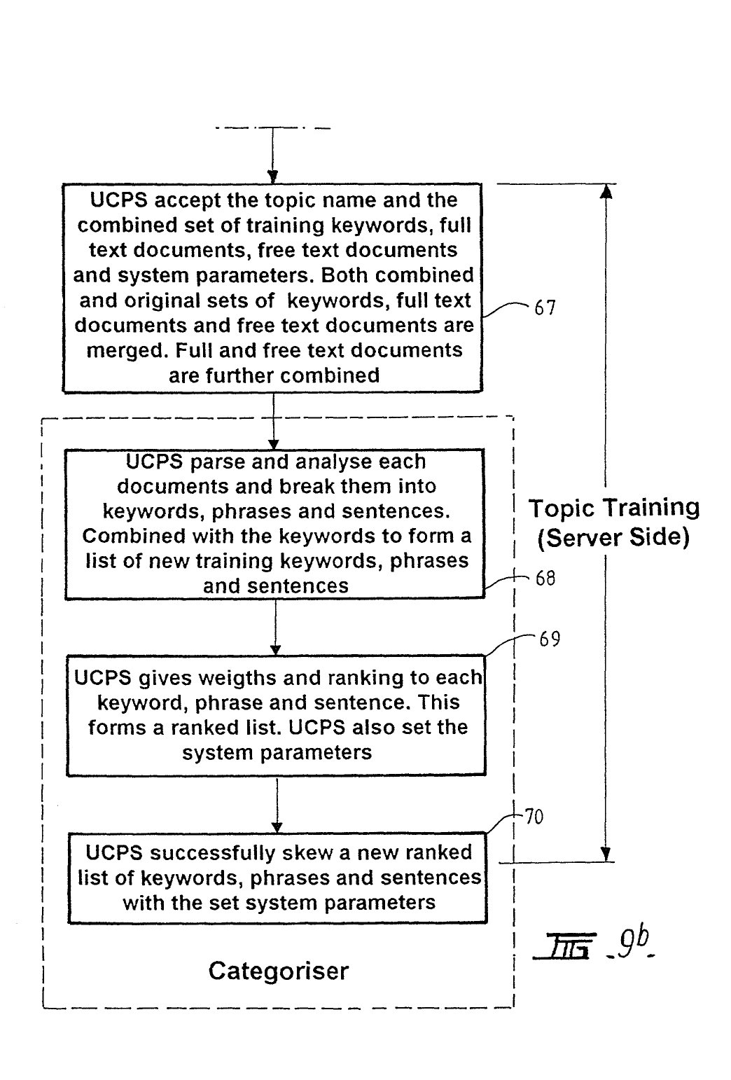

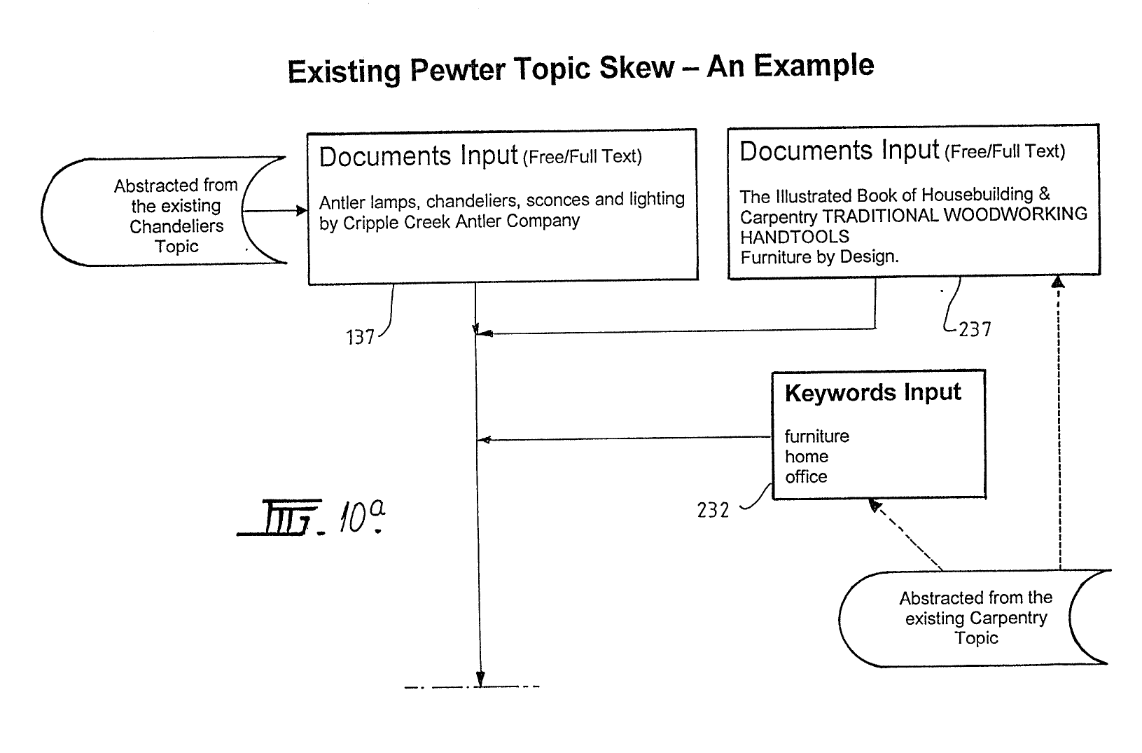

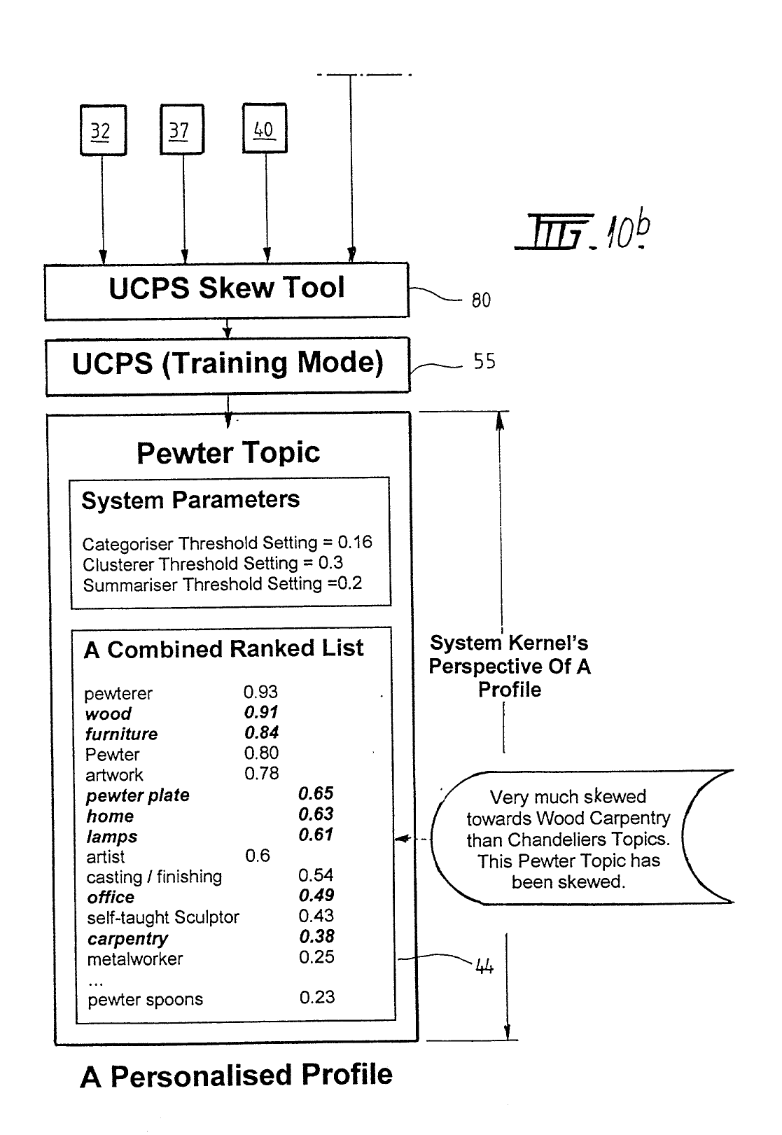

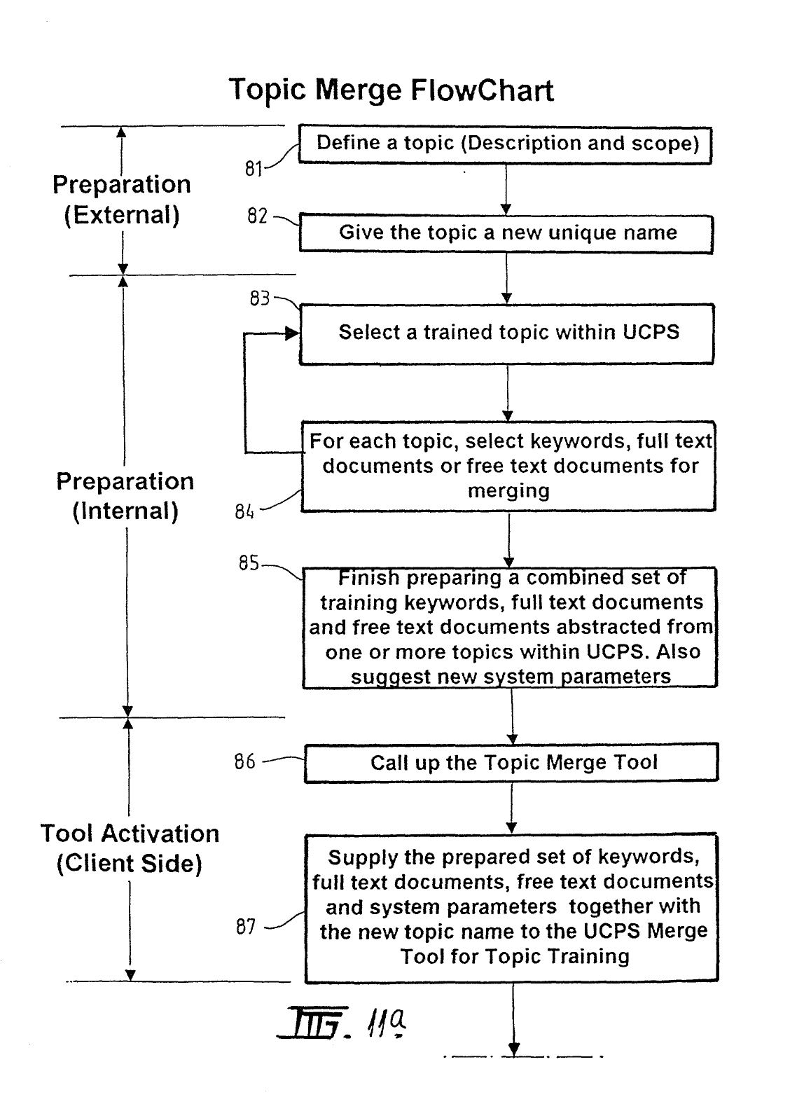

Skew: Readers are allowed to re-train the existing topic by subsets of keywords, full text documents, free text documents of other existing topics. Skewing is useful for fine-tuning of an existing topic relative to other existing topics such that documents that were originally strayed across two existing topics will not be dropped into either of the ambiguous ones but on the newly skewed topic. Skewing is also useful to re-train the existing topics. Skew operation is performed across multiple topics into a single existing topic. The flowchart is shown in FIG. 9. In steps 73, 74 (this pair of steps is performed repeatedly) a trained topic is selected, and within that selected topic, entities are selected. The total set of selected entities is edited in step 75. A topic to be skewed is selected in step 76, and any changes to its entities are made. In step 77 the skew tool is selected, and the entities of the topic to be skewed are combined with the selected entities of the other selected topics in step 78. Steps 67, 68, 69 and 70 constituting the process 55 (in FIG. 10) are then repeated. An example is shown schematically in FIG. 10. Here the topic “pewter” described in detail above, and having entities 32, 37, 40 (shown in FIG. 5) is skewed using documents 137 from the chandeliers topic and documents 237 and keywords 232 from the carpentry topic. The skew tool 80, and the training 55 (representing steps 67, 68, 69, 70) are then applied to generate a skewed topic, having a revised summary 44.

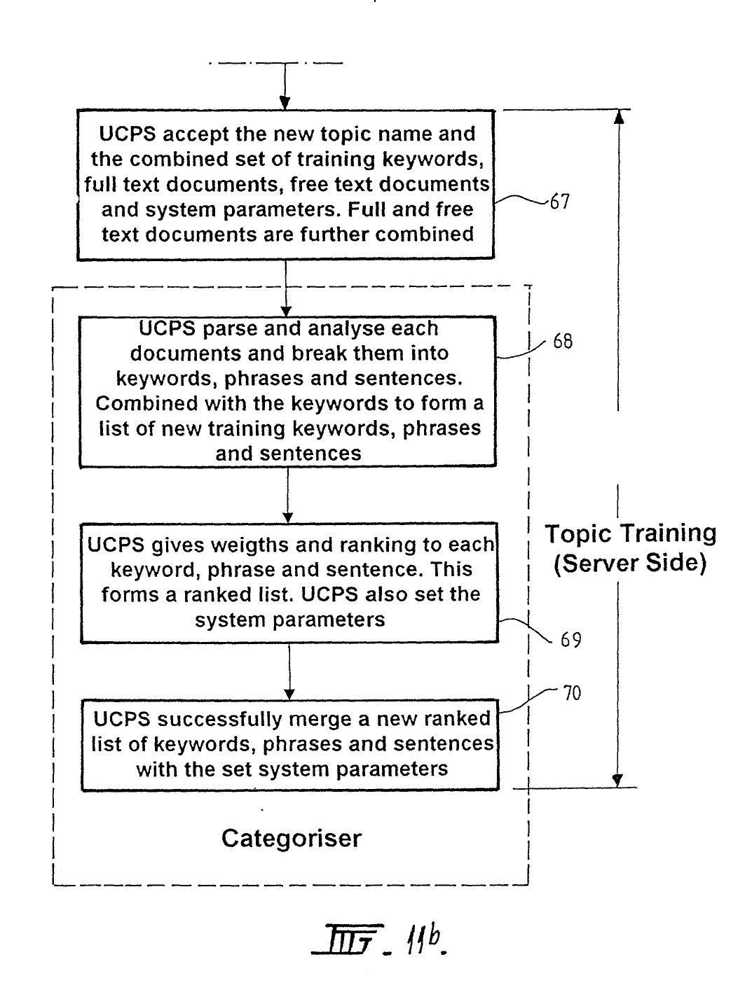

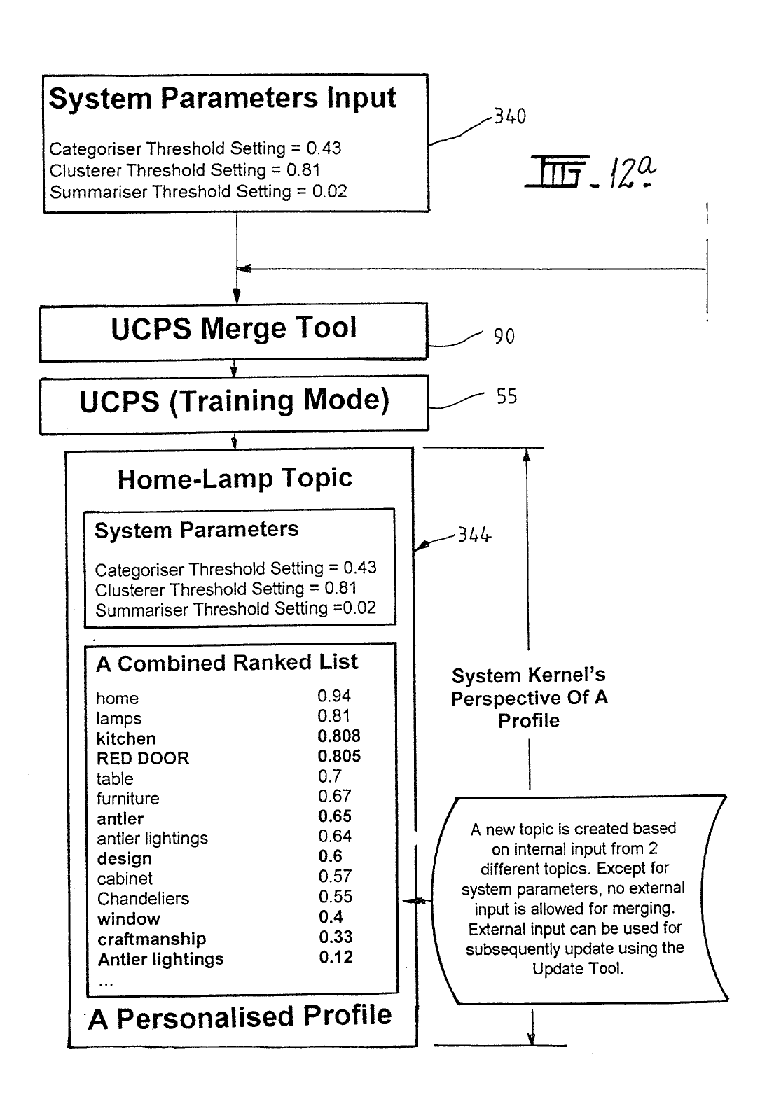

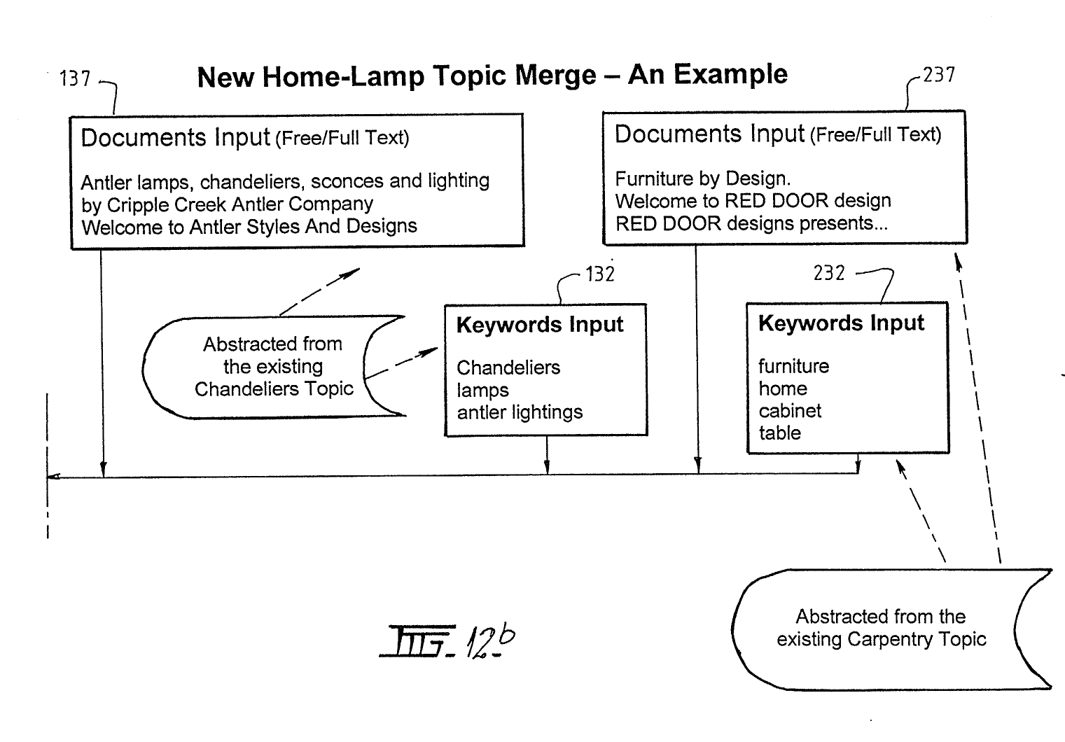

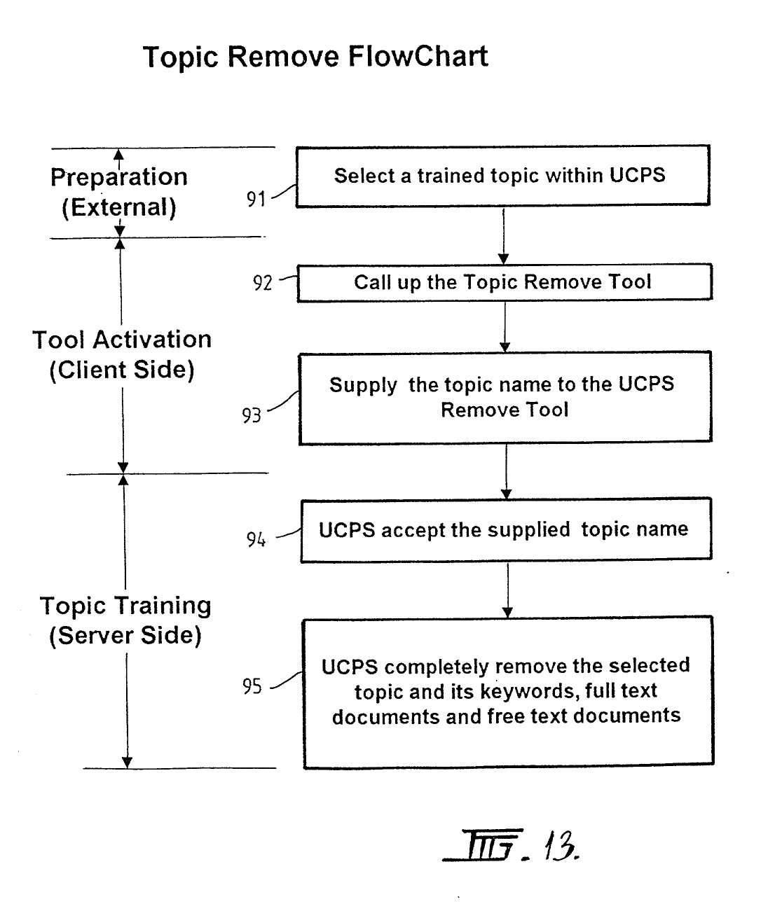

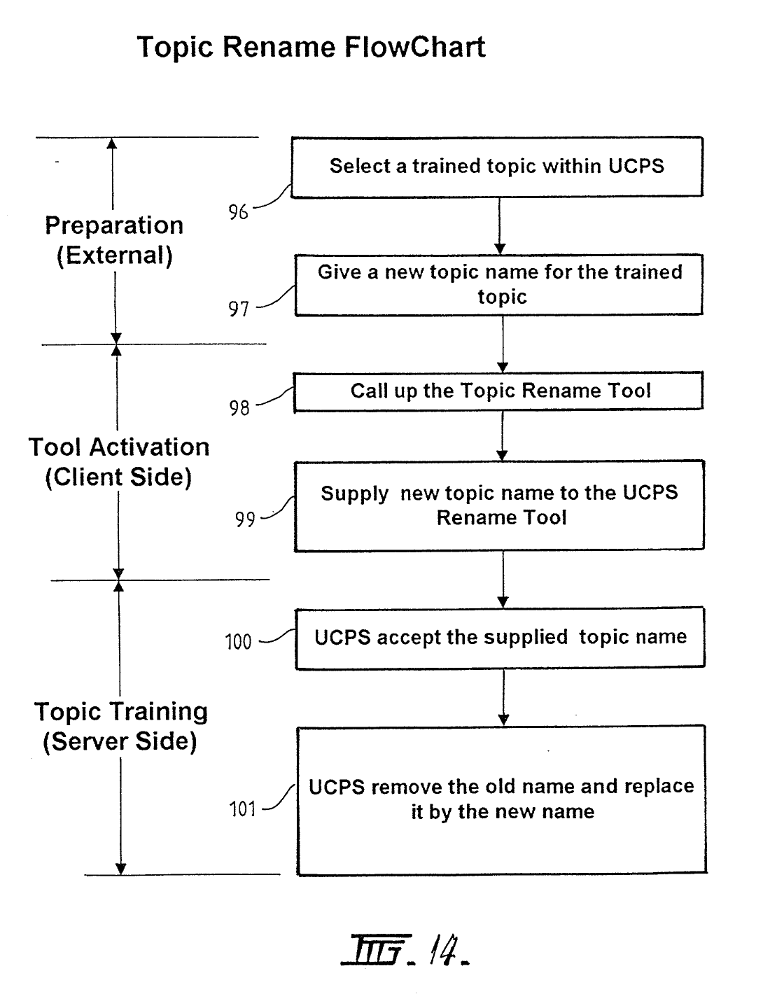

Merge: Readers are allowed to create new topic by combining two or more existing topics. Readers can use part of or full contents of the selected existing topics for merging. Merged topics will eliminate noisy words/sentences within the existing topics and automatically generate a unique topic, which will be distinct from the existing topics. It has the similar effects of skewing except that it creates a new topic, instead of operating on an existing topic in skewing operation. This operation is shown in FIG. 11. In step 81 a new existing topic is defined, and a new name is selected in step 82. In step 83 a second existing topic is selected, and the entities for that keyword are tailored in step 84. Steps 83 and 84 may be repeated if it is desired to merge one or more further topics. In step 85 the entities for all selected topics are combined, in step 86 a combine tool is called, in step the set of entities generated in step 87 is fed to the combine tool, and then the process 55 is carried out as in FIG. 7 (steps 67, 68, 69, 70). A schematic example of this is given in FIG. 12, the carpentry and chandeliers topics are merged, by combining selected entities from each with new system parameters 340 (step 85). The merge tool 50 is applied, followed by training 55, to produce a new profile “home-lamp” having a summary portion 344.

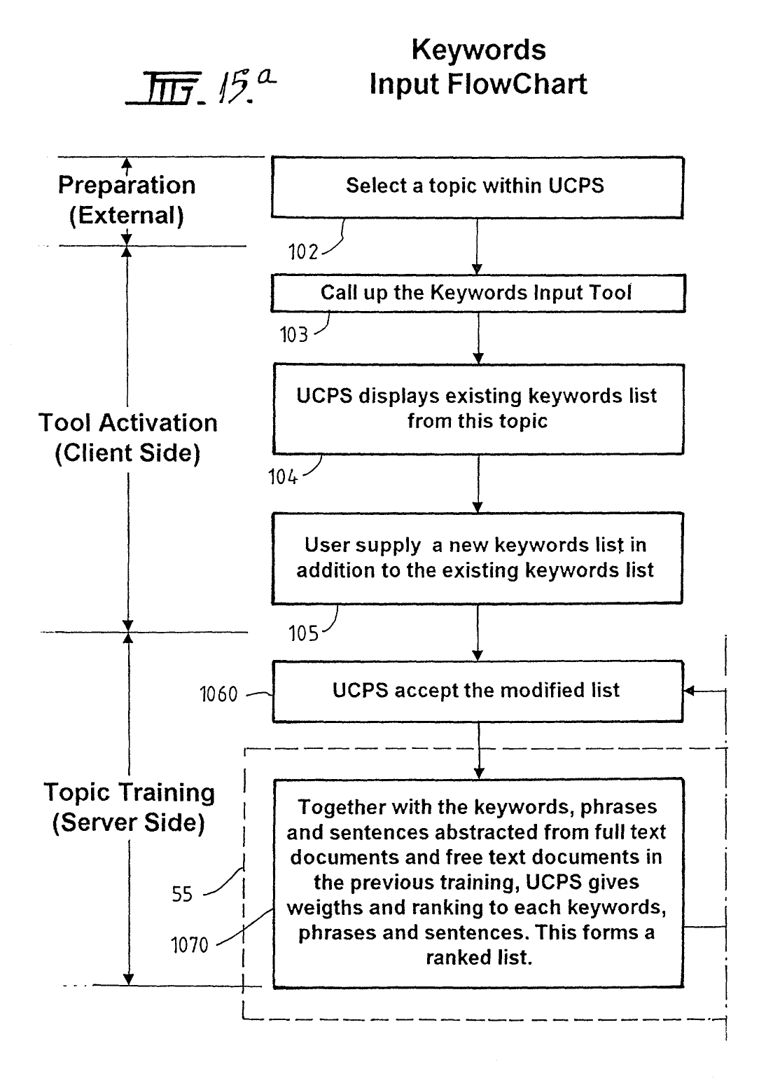

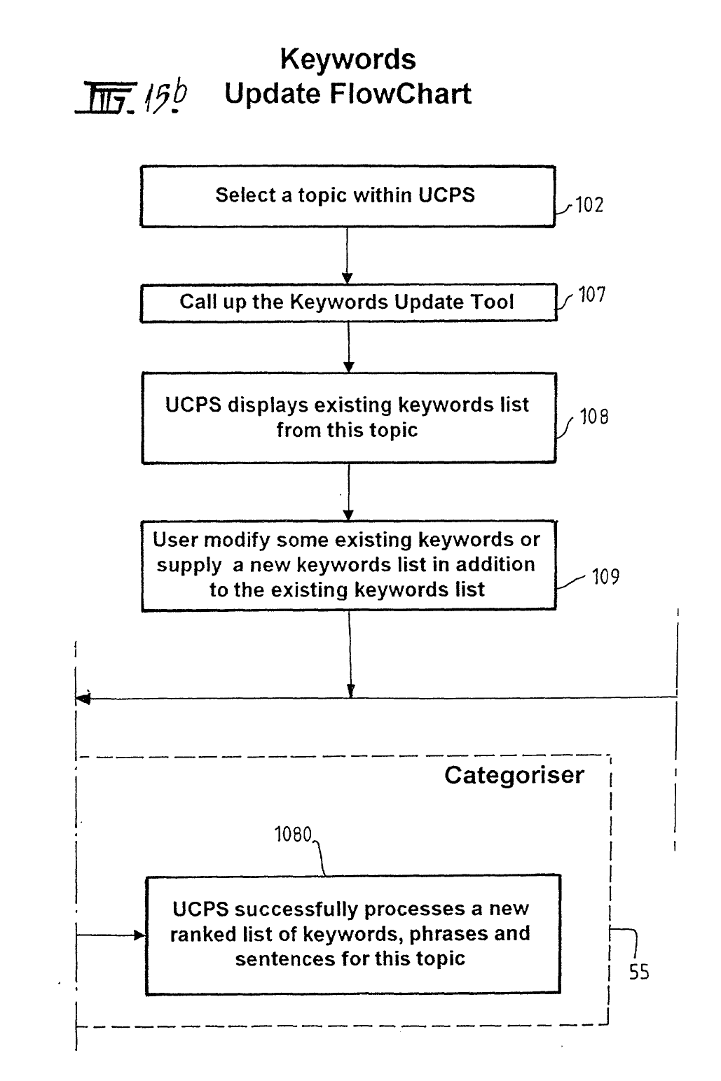

Remove: Readers are allowed to remove redundant or disinterested topics from their personal profile. The training keywords, full text documents and free text documents are removed. The flow diagram is shown in FIG. 13. It includes step 91 of selecting an existing topic, step 92 of calling the topic remove tool, step 93 of supplying the name of the selected topic to the remove tool, step 94 of the remove tool accepting the name, and step 95 of the remove tool removing the topic.

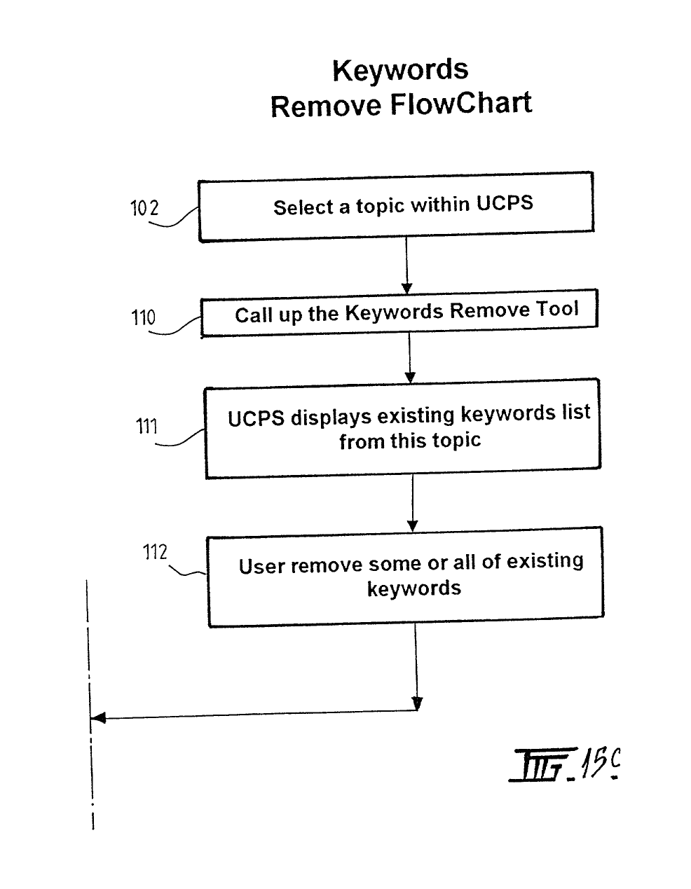

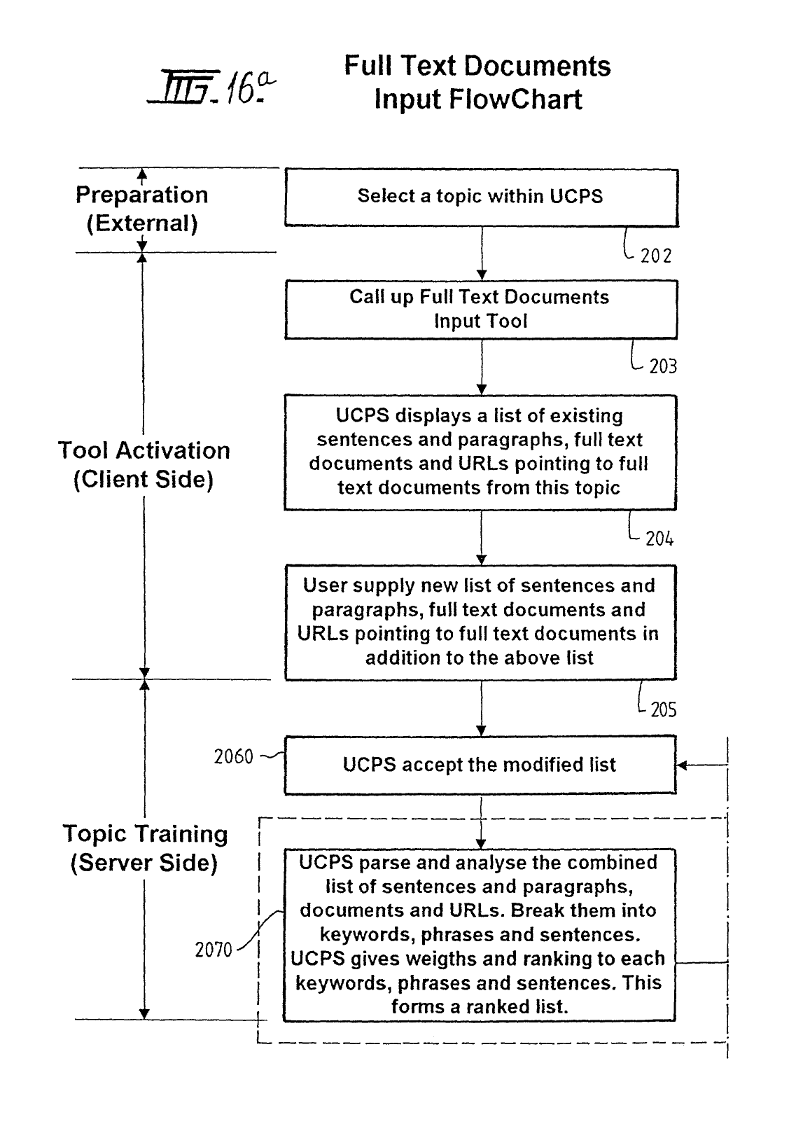

Rename: Readers can always rename their own topics. Topics of duplicated names are not allowed. Rename will not change the topic training content. Rename will retain all existing training keyword, full text documents and free text documents. The flow diagram is shown in FIG. 14. It includes steps 96 of selecting a topic, step 97 of selecting a new name (both these steps may be performed by the user merely conceptually), step 98 of calling the remove tool, step 99 of supplying the name of the selected topic to the tool, step 100 of the remove tool accepting the name and step 101 of the remove tool replacing the old topic name by the new one.

Differences between Update, Skew and Merge tools

| Update | Skew | Merge |
|---|---|---|
| Act on a single | Act on a single | Create a new topic. |
| existing topic | existing topic. | |
| Mainly using | Mainly using | Mainly using |
| keywords, full text and | keywords, full text and | keywords, full text and |
| free text documents | free text documents | free text documents |
| from external | from existing topics | from existing topics |
| environment. | within the internal | within the internal |
| | environment | environment. |
| Minor activity | Major activity | Major activity |
| When used, it focuses | When used, it focuses | When used, it focuses |
| on improving individual | on re-training an on | creating new topics |
| topic. Ignore other | existing topic either | through two or more |
| relevant existing topics | towards a new/ | existing topics. |
| within the system, even | modified concept or | |
| if they are quite similar. | away from other | |
| | relevant topics. | |
| The Graphical User | The Graphical User | The Graphical User |
| Interface will not be | Interface will be | Interface will be |
| showed with information | showed with | showed with only |
| about other existing | information about | information about |
| topics, but new and | other existing topics, | other existing topics. |
| existing entries for | together with the | |
| keywords, full text and | existing entries for | |
| free text documents. | keywords, full text and | |
| | free text documents. | |
| No selection of existing | Not allowed to select | Must select part or |
| topics. | whole part of any | whole part of any |
| | existing topics. | existing topics. |

We now turn to manipulations of the entities themselves. These methods are used for example in step 72 of FIG. 8.

2. Keyword Manipulation

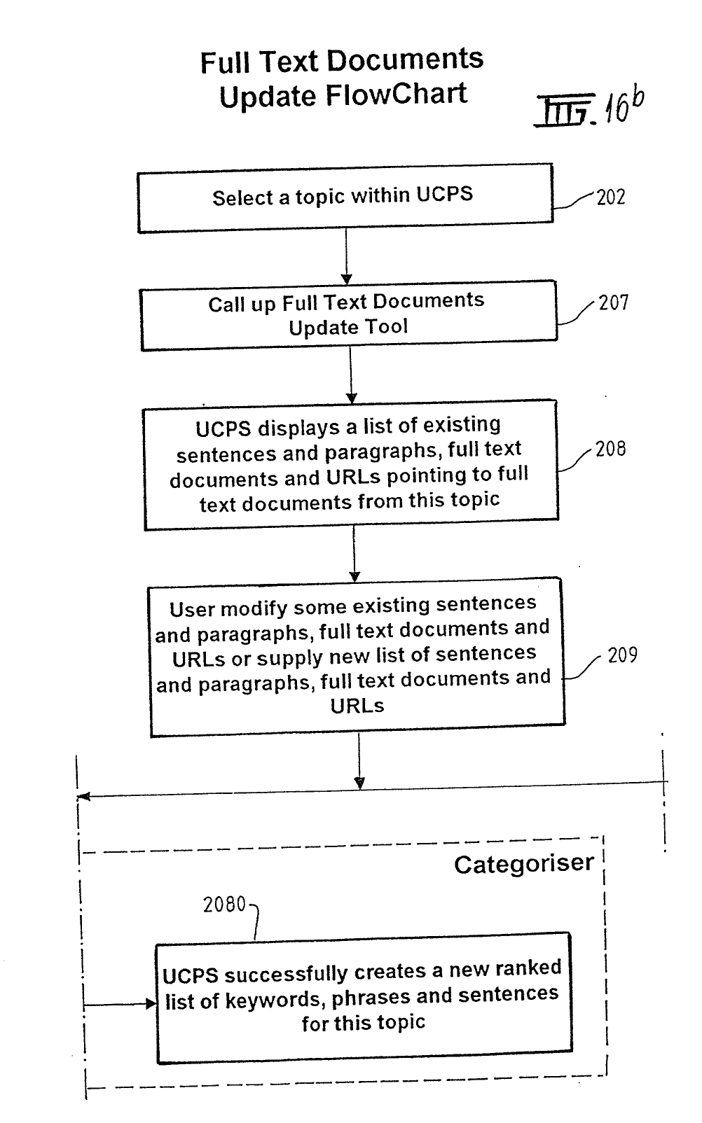

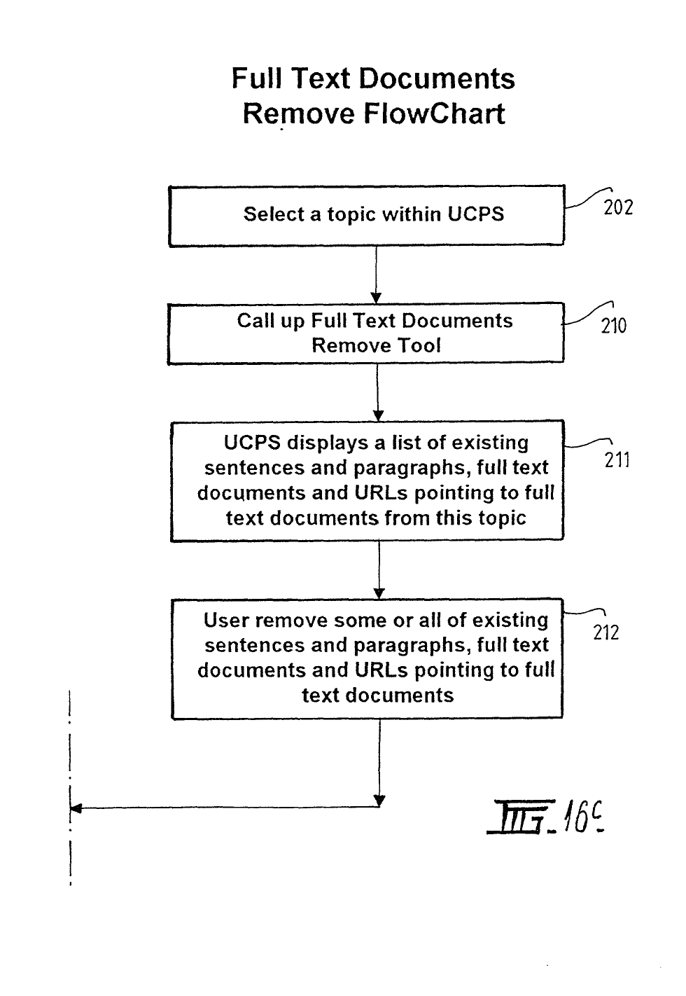

Each keyword can be manipulated by a set of keyword tools. They are the Input, Update and Remove, and are illustrated with reference to FIG. 15

Input: Readers are allowed to input a list of keywords, in the form of single English word, combination of single English words or a phrase, such that they represent the most wanted entities in the personalized documents. In step 102 a user selects a topic, in step 103 the user calls the keyword input tool, in step 104 the UCPS displays the existing keywords for the selected topic, in step 105 the user adds extra keywords, in step 1060 the UCPS accepts the modified list, and in steps 1070 and 1080 the method performs respective steps of re-evaluating rank values for the keywords and producing a new ranked list of keywords. These last steps are effectively the training process 55 explained above.

Update: Readers are allowed to modify the existing list of keywords in the form of single English word, combination of single English words or a phrase. Modification can be changes in spellings, grammatical correction in phrases etc. In this case, following step 102, the user calls the update keywords tool (step 107), the UCPS displays the existing keywords for that tool (step 108), the user modifies these keywords (step 109) and then steps 1060, 1070, 1080 are carried out as explained above.

Remove: Readers are allowed to remove the existing list of keywords. After step 102, the user calls the remove keywords tool (step 110), the UCPS displays the existing keywords for the selected topic, (step 111), the user removes some of the keywords (step 112) and then steps 1060, 1070, 1080 are performed as explained above.

3. Full Text Document Manipulation

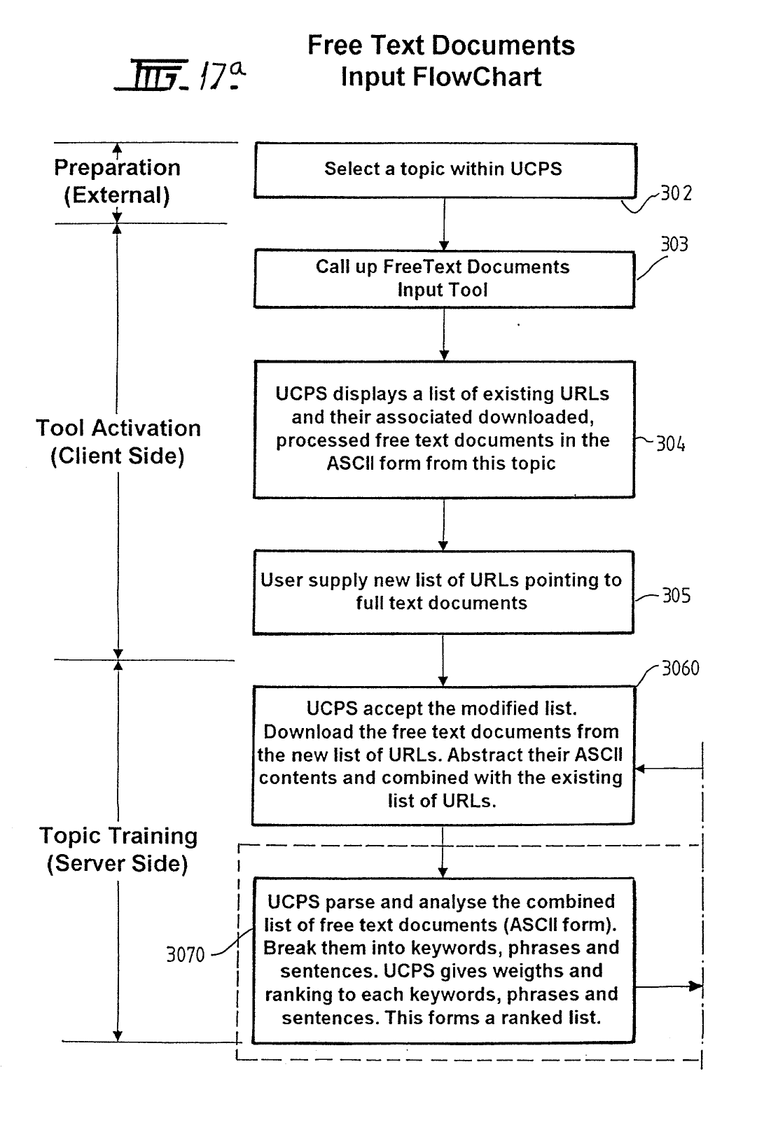

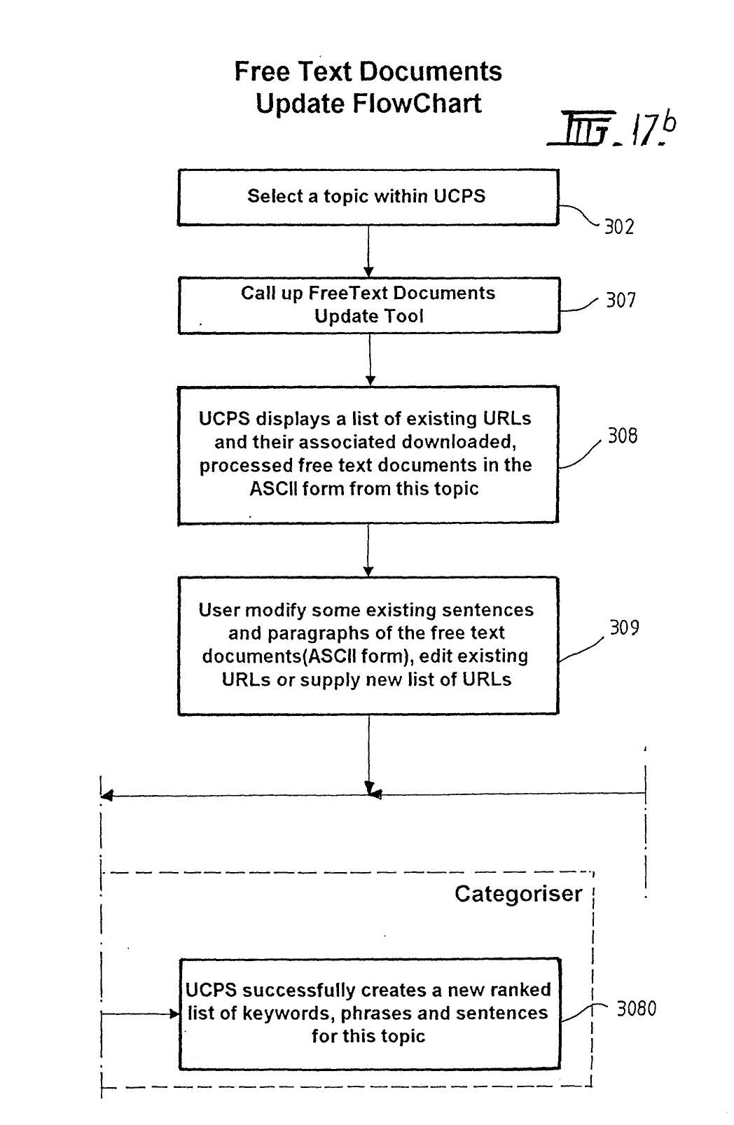

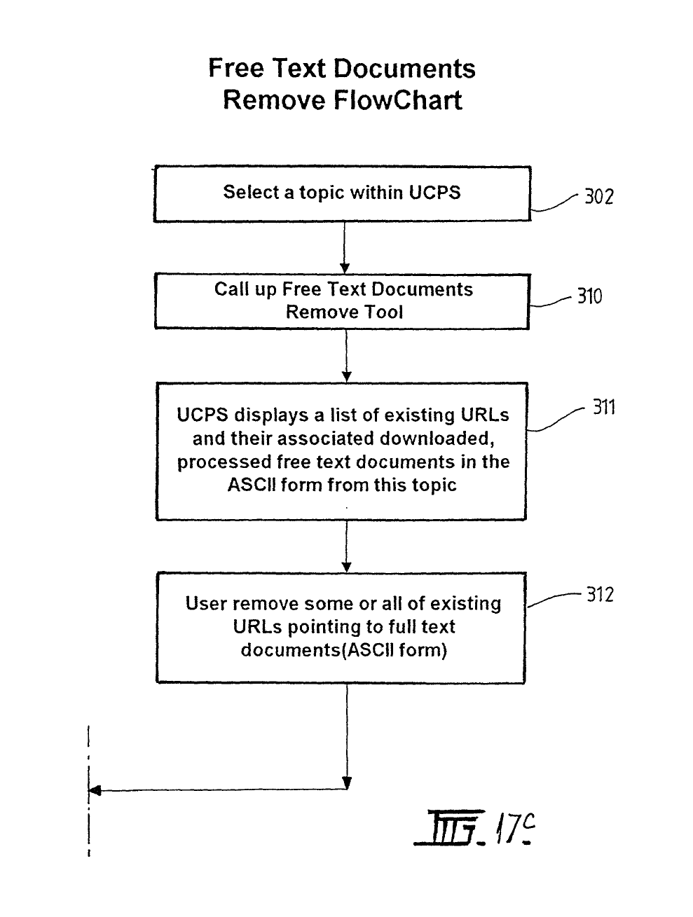

Each full text document can be manipulated by a set of full text document tools. They are the Input, Update and Remove, and are explained below with reference to FIG. 16.

Input: Readers are allowed to input any length of sentences and paragraphs, per full text document, constituting sufficient knowledge to represent readers' intended interests and needs for a particular topic. Readers can input as many as full text documents as possible. Readers can input URL pointing to full text documents. The documents will be downloaded and stored into the system. The steps are 202, 203, 204, 205, 2060, 2070, and 2080 corresponding respectively to steps 102, 103, 104, 105, 1060, 1070 and 1080 in FIG. 15.

Update: Readers are allowed to modify the existing sentences and paragraphs of documents to reflect more current interests or perform correction in the original input. Modification can be done by document to include changes in word spellings, grammatical correction in sentences and paragraphs or replacing the whole document content etc. Readers can also edit the URL. Full text documents pointed by the new URL will be downloaded and stored into the system. The old documents pointed by the old URL will be removed from the system permanently. The steps are 202, 207, 208, 209, 2060, 2070, 2080 corresponding respectively to steps 102, 107, 108, 109, 1060, 1070, 1080 in FIG. 15.

Remove: Readers are allowed to remove the whole documents and URL. The documents downloaded because of these URL will also be removed permanently. The steps are 202, 210, 211, 212, 2060, 2070, 2080 corresponding respectively to steps 102, 110, 111, 112, 1060, 1070, 1080 in FIG. 15

4. Free Text Document Manipulation

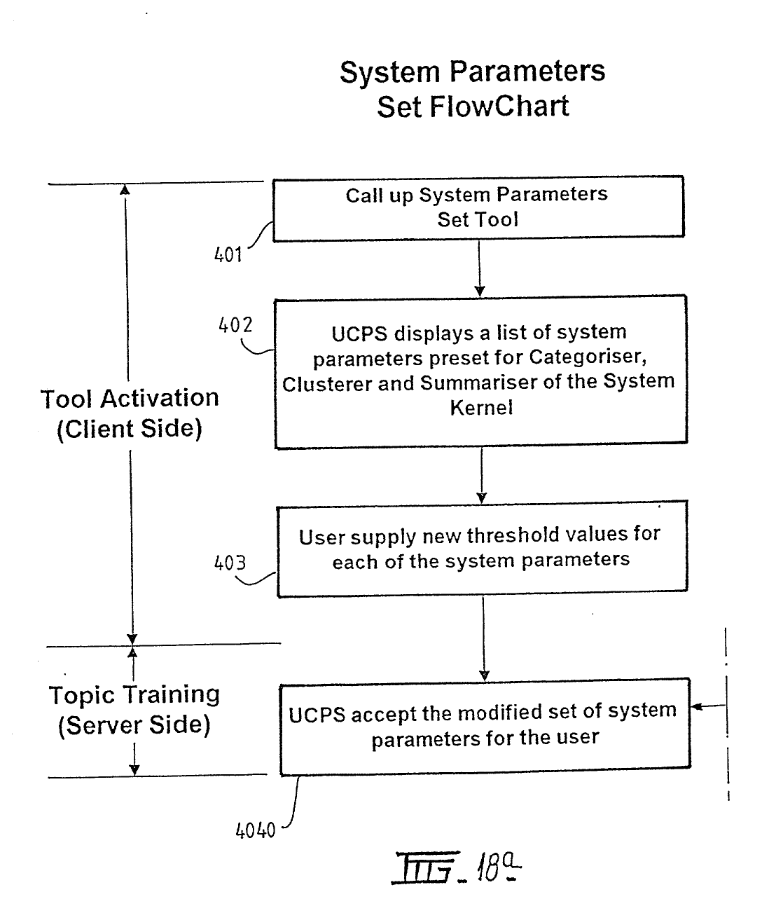

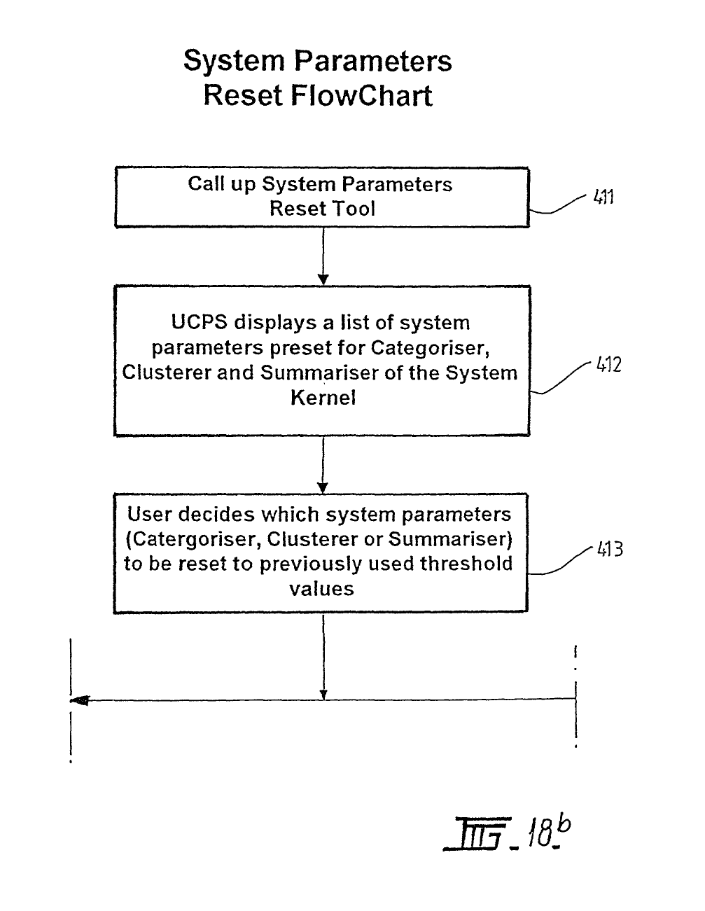

As illustrated in FIG. 17, each free text document can be manipulated by a set of free text document tools. They are the Input, Update and Remove.

Input: Readers can input URL pointing to free text documents. The free text documents will be downloaded, abstract their ASCII text portions, and stored the ASCII texts into the system. Readers are allowed to view the downloaded documents. The steps are 302, 303, 304, 305, 3060, 3070, 3080 corresponding respectively to steps 102, 103, 104, 105, 1060, 1070, 1080 of FIG. 15.

Update: Readers are allowed to modify the existing sentences and paragraphs of the downloaded documents to reflect current interests better or to remove noises in the downloaded documents. Modification can be changes in word spellings, grammatical correction in sentences and paragraphs etc. The steps are 302, 307, 308, 309, 3060, 3070, 3080 corresponding respectively to steps 102, 107, 108, 109, 1060, 1070, 1080 of FIG. 15.

Readers can also edit the URL. Free text documents pointed by the new URL will be downloaded, abstracted and stored into the system. The old documents pointed by the old URL will be removed from the system permanently.

Remove: Readers are allowed to remove the URL. The documents downloaded because of these URL will also be removed permanently. The steps are 302, 310, 311, 312, 3060, 3070, 3080, corresponding respectively to steps 102, 110, 111, 112, 1060, 1070, 1080 in FIG. 15.

5. System Parameter Definition & Selection

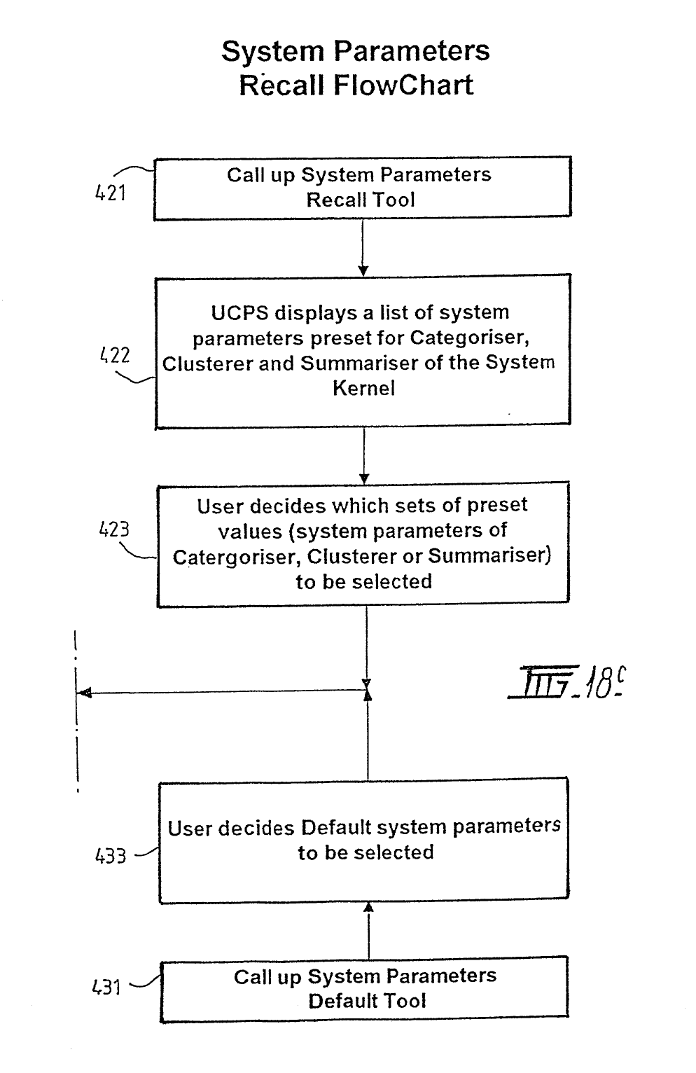

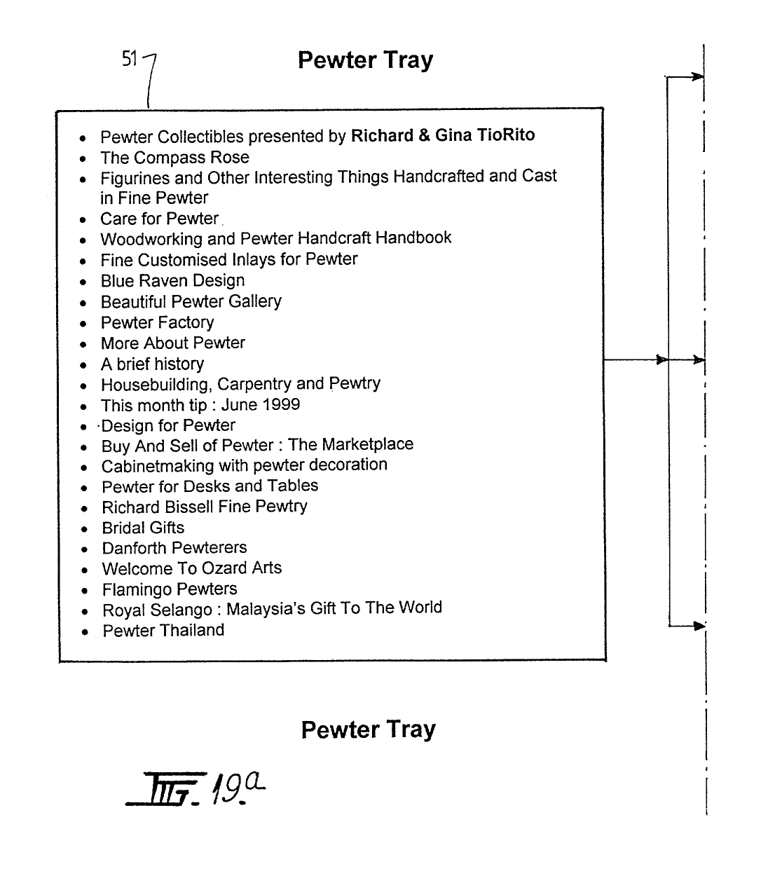

Each system parameter can be manipulated by a set of system parameter tools. They are Set, Reset, Recall and Default illustrated in FIG. 18.

Set: Readers can set threshold values in steps 401 of selecting the set tool, 402 of the UCPS displaying the existing thresholds, step 403 of the user supplying new thresholds and step 4040 of the UCPS accepting the modified thresholds.

Reset: Readers can restore the preset values. Preset values are the latest values used by system kernel during content personalization. Reset operation can be done at individual parameter or group of parameters. The steps are 411 of calls the parameter reset tool, step 412 of displaying existing parameters, 413 of deciding which parameters to reset, followed by step 4040 as explained above.

Recall: Readers can request system to present the last preset values for reuse. Recalled values are used by system for content personalization in the past. Reset operation can be done at individual parameter or group of parameters. The steps are 421 of calling the parameter recall tool, 422 of the system displaying existing values, 423 of the user deciding which to recall, followed by step 4040 as explained above.

Default: Readers can restore all system parameters to publisher's preset values. Default operation can only be done at group level. The steps are 431 of calling the parameters default tool, 433 of deciding which parameters to return to default values, followed by step 404 as described above.

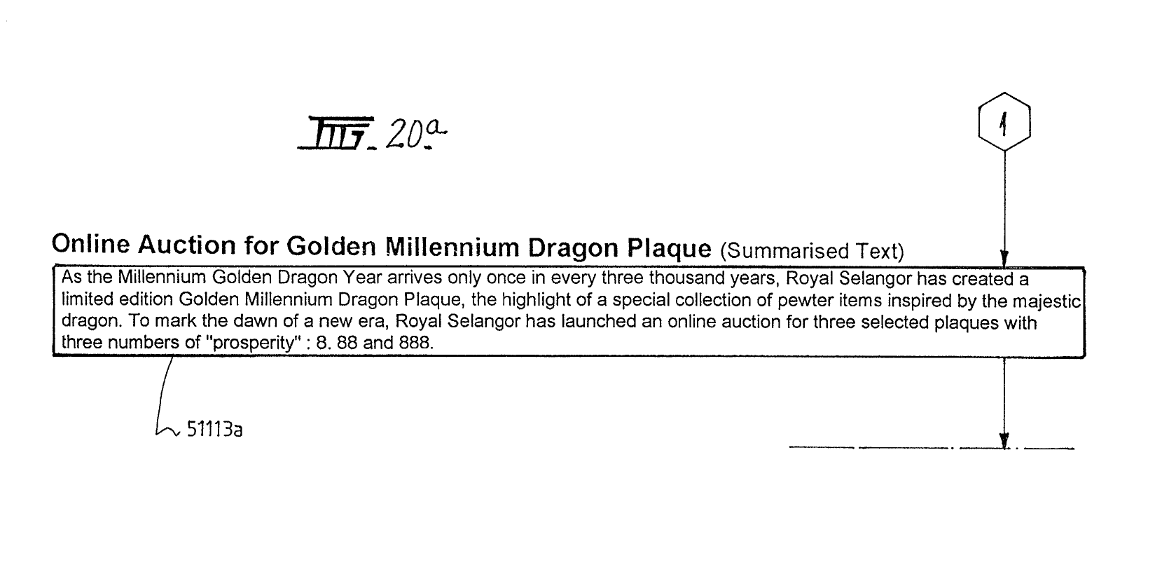

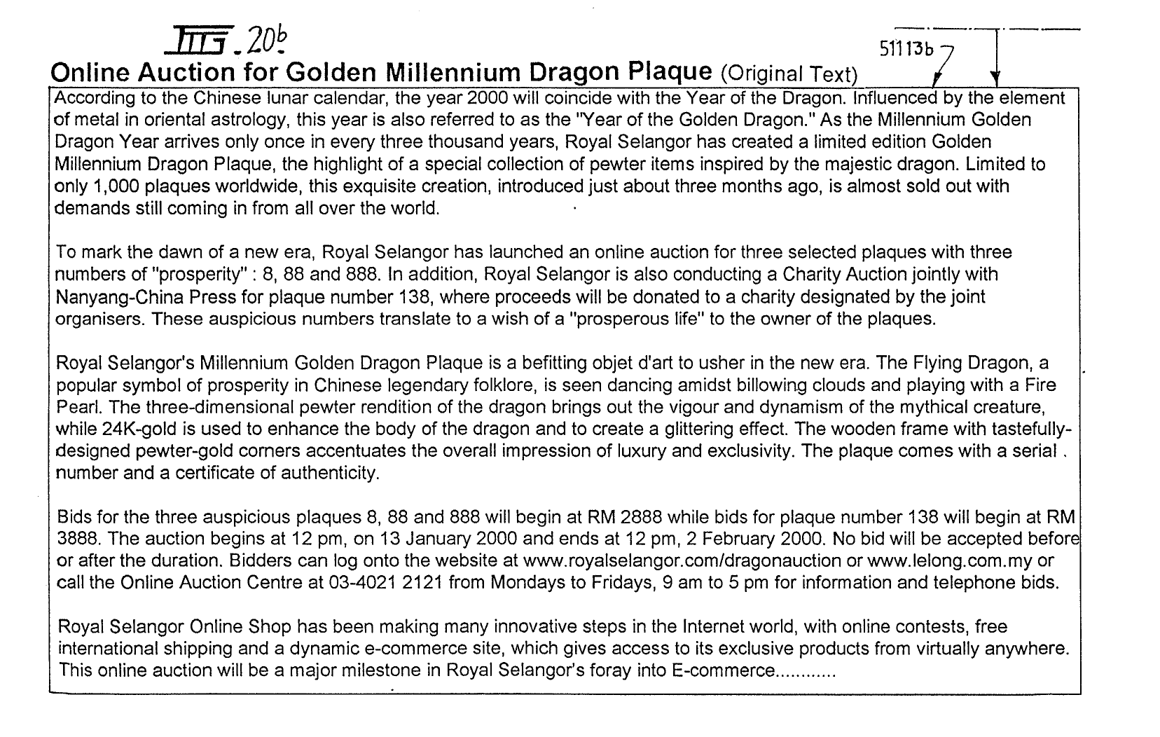

We now turn to an explanation of the other content processing subsystems 14 shown in FIG. 1, the use of which is optional. This explanation is in relation to FIGS. 19 to 20. The content processing subsystems 14 include a clustering tool and a summarisation tool.

As shown in FIG. 19, the kernel 9, separates the documents into four categories based on the profile summary and the categoriser threshold. This scheme may be extended, as shown in FIG. 19 so that documents which have already been classified into one of the categories are subject to a further level of categorisation into clusters, each category being associated with one or more clusters. Thus, the category “pewter tray” in FIG. 4 may be associated with two clusters “buy and sell” and “design and handcraft”. Each cluster which may also be referred to as a theme, a knowledge concept.

The clusterer threshold setting of the profile mentioned above determines the required level of similarity between a given document and a set of information associated with the cluster (for example, a list of keywords associated with the cluster; the information associated with a given cluster may optionally be a subset of the information in the profile for that category) such that the document is transmitted to a tray 511 or 512 associated with that cluster. Documents for which the similarity is not as great as the cluster threshold setting are sent to a tray 510 and labelled “unclustered”. Thus, the clusterer threshold setting of the system parameters 44 of FIG. 2 is used to control the size (maximum number of documents) of the clusters.

Further information on methods suitable to perform clustering in embodiments according to the present invention, is available at the web site http://www-4.ibm.com/software/data/iminer/fortext/cluster/cluster.html, for example.

Furthermore, each document which is allocated to a given cluster, before it is presented to a user, be subject to a group summarisation performed by a summarization tool based on the summariser threshold setting. Techniques for summarisation which are suitable for use in the present invention are disclosed for example at

http://www.ibm.com/software/data/iminer/fortext/summarize/summarize.html.

Thus, as shown in FIG. 19, one or more sets of documents of a given cluster (i.e. sets of documents of that cluster having a certain mutual similarity) are used to produce a brief group summary. For example, the three documents in set 5111 in FIG. 19 (each associated with cluster 511 and having a mutual similarity above a certain level) are used to produce a multidocument summary “Pewter is on high demand”.

If a user decides that the document 51113 (with title “Online auction for Golden Millennium Dragon Plaque”) is of interest, he can indicate his interest (as indicated in step 1). In this case, as indicated in FIG. 20, the user is shown a summary 51113a of the document (generated by the summarisation tool). If, based on summary 51113a, the user decides that the document is of sufficient interest, he can ask for the entire document 51113 to be displayed, as shown in FIG. 20 in the box 51113b.

Clustering and summarization are not the only possible content processing subsystems 14. Other possible text mining technologies are presently disclosed at http://www-4.ibm.com/software/data/iminer/fortext/index.html, for example.

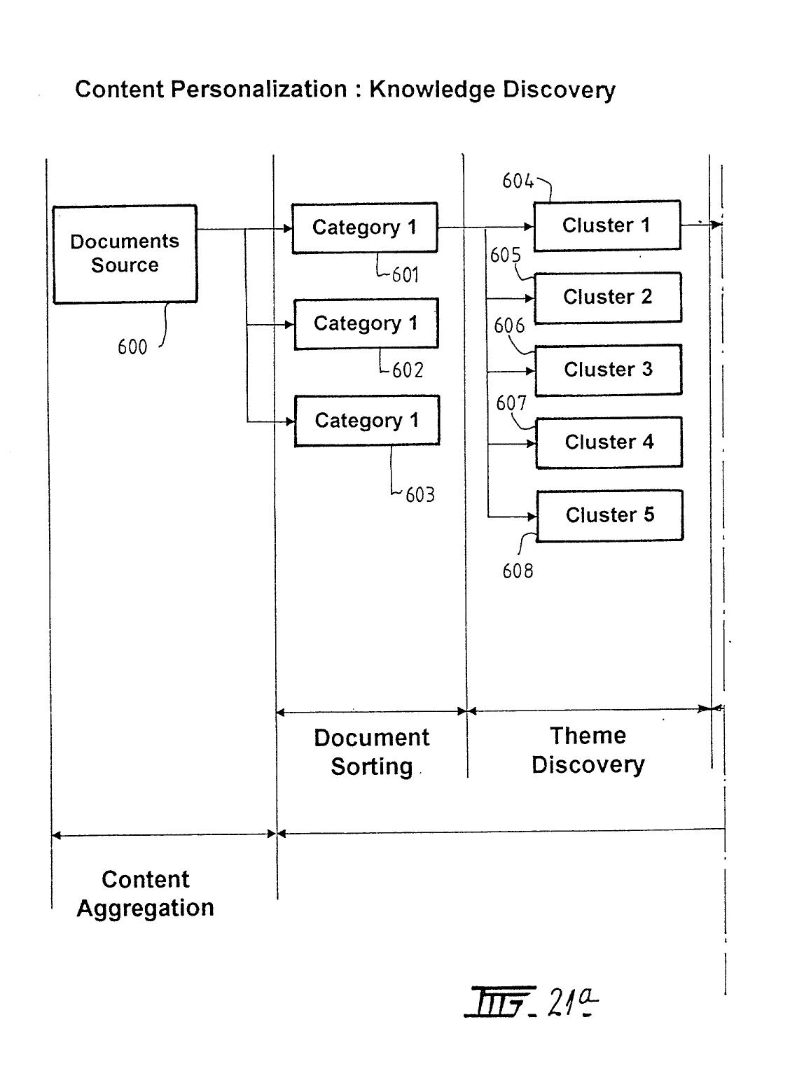

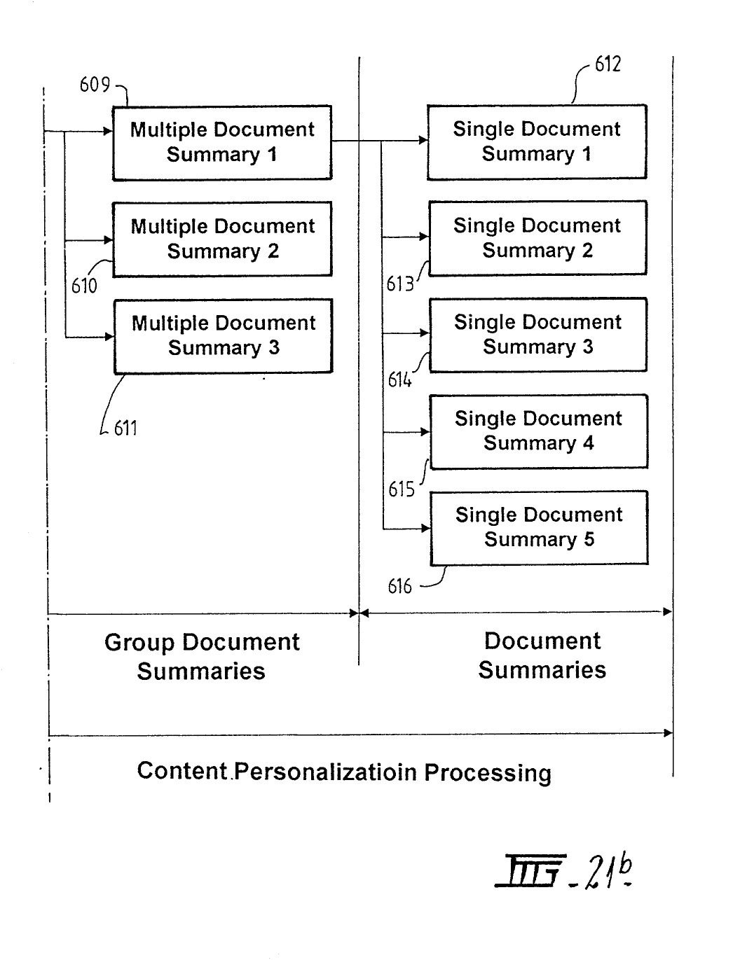

FIG. 21 summarises the content personalization of the knowledge discovery device of the embodiment. After the content aggregation stage shown in FIGS. 1 and 21, documents from a document source 600 are divided into categories 601, 602, 603. Documents of each category are further classified into clusters 604, 605, 606, 607, 608. Sets of one or more documents within a single cluster are used to produce multiple document summaries 609, 610, 611 of each respective set. The summarisation tool further produces (e.g. on demand) summaries 612, 613, 614, 615, 616 of one or more respective documents in any set.

1. A computer-implemented method of generating a user personalised filter for processing files, the method comprising the steps of:
(a) establishing communication with a server;
(b) employing at least one software tool operated by the server to generate a personal profile, the profile comprising one or more topics, and associated with the or each topic, at least one keyword and at least one text document;
(c) employing processing software operated by the server to generate, for the or each topic, a filter from the associated keywords and text documents.

2. A method according to claim 1 wherein said text documents comprise at least one first text document consisting only of text and at least one second text document comprising both text and at least one multimedia file, said step of generating the filter operating on at least the text portion of the second text document.

3. A method according to claim 2 in which said multimedia file is one of (i) an image file, (ii) a video file or (iii) a sound file.

4. A method according to claim 1 in which, in said step of employing said software tool, the user inputs at least one said text document.

5. A method according to claim 1 in which, in said step of employing said software tool, the user inputs a location of at least one said text document, and an application program operated by the server downloads the at least one text document from the location, such as through an open communication protocol interface.

6. A method according to claim 1 in which the or each topic describes a focused information interest or need of the user

7. A method according to claim 1 in which each of the keywords is one of (i) a single natural language word, (ii) a combination of single natural language words or (iii) a phrase.

8. A method according to claim 1 wherein the tools include tools to perform at least one of the operations of (i) creating, (ii) updating, (iii) combining, (iv) removing and (v) renaming the topics.

9. A method according to claim 1 wherein said tools include tools to perform at least one of the operations of (i) inputting, (ii) updating and (iii) removing keywords.

10. A method according to claim 1 wherein said tools include tools to perform at least one of the operations of (i) inputting, (ii) updating and (iii) removing text documents.

11. A method according to claim 1 in which each filter further comprises for each topic at least one numerical parameter, said parameter being for controlling the processing of documents based on said filter.

12. A method according to claim 11 wherein the tools include tools to perform at least one of the operations of (i) setting and (ii) resetting said parameters, or returning said parameters to (iii) previous values or (iv) default values.

13. A computer-implemented method of generating a user personalised filter for processing files, the method comprising the steps of:
(a) establishing communication with a server;
(b) employing at least one software tool operated by the server to generate a personal profile by inputting data, said profile comprising input data associated with at least two topics;
(c) employing processing software operated by the server to generate, for each topic, a filter from the respective input data;
(d) employing combination software operated by the server to combine the input data from at least two of the topics, and the processing software to generate a new filter based on the combined input data.

14. A method according to claim 13 wherein the new filter replaces an existing filter.

15. A method according to claim 13 wherein the new filter supplements the existing filters.

16. A method according to claim 1 wherein said step of establishing communication with a server is performed by a user employing a HTTP browser operated by a first computer system, the server comprising an HTTP server application program operated by a second computer system.

17. A method according to claim 13 wherein said step of establishing communication with a server is performed by a user employing a HTTP browser operated by a first computer system, the server comprising an HTTP server application program operated by a second computer system.

18. A method of processing a plurality of files in a database, the method including:
generating at least one filter according to any preceding claim;
for each filter, determining a relevance of each file to the topic associated with each filter by comparing the file to the filter, and process the files on the basis of the processing parameter.

19. A method according to claim 11 in which:
said parameters include at least one processing parameter;
said step of comparing the file to the filter includes deriving a numerical relevance index of the file to the respective topic, and
for a file for which the relevance parameter is lower than said processing parameter, the file is assessed to be unrelated to the respective topic.

20. A method according to claim 19, in which the files for which the relevance parameter is above the processing parameter are transmitted to the user.

21. A method according to claim 19 wherein the said user can instruct the server to cache any files for which the relevance parameter is above the processing parameter until it is needed by the said user.

22. A method according to claim 18 in which:
said parameters include at least one processing parameter;
said step of comparing the file to the filter includes deriving a numerical relevance index of the file to the respective topic, and
for a file for which the relevance parameter is lower than said processing parameter, the file is assessed to be unrelated to the respective topic.

23. A method according to claim 22, in which the files for which the relevance parameter is above the processing parameter are transmitted to the user.

24. A method according to claim 22 wherein the said user can instruct the server to cache any files for which the relevance parameter is above the processing parameter until it is needed by the said user.

25. A method according to claim 1 which is performed at predetermined time intervals.

26. A computer apparatus arranged for communication with at least one user, the apparatus comprising:
one software tool controllable by the user to generate a personal profile, the profile comprising one or more topics, and associated with the or each topic, at least one keyword and at least one text document; and
processing software to generate, for the or each topic, a filter from the associated keywords and text documents.

27. A computer apparatus arranged for communication with at least one user, the apparatus comprising:
at least one software tool controllable by the user to generate a personal profile by inputting data, said profile comprising input data associated with at least two topics;
processing software controllable by the user to generate, for each topic, a filter from the respective input data;
combination software controllable by the user to combine the input data from at least two of the topics; and
processing software to generate a new filter based on the combined input data.

28. A computer program product, such as a recording medium, readable by a computer apparatus and which causes the computing apparatus to operate as a computing apparatus according to claim 26.

29. A computer program product, such as a recording medium, readable by a computer apparatus and which causes the computing apparatus to operate as a computing apparatus according to claim 27.
